(19) United States
(12) Patent Application Publication
(10) Pub. No.: US 2023/0418176 A1
(43) Pub. Date: Dec. 28, 2023

(54) TONER

(71) Applicant: CANON KABUSHIKI KAISHA, Tokyo (JP)

(72) Inventors: MARIKO YAMASHITA, Shizuoka (JP); TAKASHI MATSUI, Shizuoka (JP); KENJI AOKI, Shizuoka (JP); YUHEI TERUI, Shizuoka (JP); SHINTARO NOJI, Shizuoka (JP)

(21) Appl. No.: 18/339,875

(22) Filed: Jun. 22, 2023

(30) Foreign Application Priority Data
Jun. 22, 2022 (JP) 2022-100446

(51) Int. Cl. G03G 9/087; G03G 9/083

(52) U.S. Cl. CPC G03G 9/08733; G03G 9/0839; G03G 9/08728

(57) ABSTRACT

A magnetic toner comprising a toner particle, the toner particle comprising a magnetic body, a crystalline resin A, and an amorphous resin B. The crystalline resin A has a monomer unit (a). The amorphous resin B has a monomer unit (b). A content of the crystalline resin A in the toner is 6.2 to 77.0 mass %. The sum of contents of the crystalline resin A and the amorphous resin B in the toner is 30.0 mass % or more. A content of the monomer unit (a) in the crystalline resin A is 50.0 to 100.0 mass %. Using SPA [(J/cm³)^{0.5}] for a SP value of the crystalline resin A and using SPB [(J/cm³)^{0.5}] for a SP value of the amorphous resin B, SPA and SPB satisfy 0.15≤SPB−SPA≤2.00.

### BACKGROUND OF THE INVENTION

### Field of the Invention

The present disclosure relates to the toner used in electrophotographic methods and electrostatic recording methods.

### Description of the Related Art

Energy savings have come to be regarded in recent years as a major technical issue for electrophotographic devices, and substantial reductions in the amount of heat required by the fixing apparatus are desired. In particular, with regard to the toner, there is great need for fixing to be made possible at lower energies, i.e., for “low-temperature fixability”.

Toner to which plasticizer has been added has been considered, for example, in WO 2013/047296, as a technique for enabling fixing at low temperatures. The plasticizer operates to speed up the softening rate of the binder resin while maintaining the glass transition temperature (Tg) of the toner unchanged and can thus improve the low-temperature fixability. However, the toner softens via a step of plasticization of the binder resin after the plasticizer has melted, and as a consequence there is a limit on the toner melting rate and additional improvements in the low-temperature fixability are desired.

The method of using a crystalline resin as the binder resin has therefore been considered. The molecular chains in a crystalline resin exhibit a regular arrangement, and due to this a crystalline resin has the property of undergoing almost no softening at temperatures below the melting point. In addition, the crystals melt rapidly when the melting point is exceeded and a rapid decline in the viscosity occurs in association with this. As a consequence, crystalline resins have been receiving attention as materials that have an excellent sharp melt property and exhibit low-temperature fixability.

Side-chain crystalline resins are one example of the crystalline resins used for the binder resins in toners. A side-chain crystalline resin is a vinyl polymer in which a monomer unit having a long-chain alkyl group in side chain position is incorporated in the main chain of the molecule. A side-chain crystalline resin has a long-chain alkyl group in side chain position in the molecule and exhibits crystallinity because the side-chain long-chain alkyl groups assume a regular arrangement with each other, both intramolecularly and intermolecularly, resulting in crystallization. A crystallized side-chain crystalline resin exhibits a sharp melt property because the molecules readily disengage, and as a result has properties favorable for low-temperature fixing. On the other hand, due to a tendency for the electrical resistance to be low, toner that contains a large amount of side-chain crystalline resin has suffered from the problems of readily taking on a low charge retention and readily exhibiting a decline in the developing performance.

In the case of magnetic toners, the magnetic body, which exhibits a low electrical resistance, also becomes a source of charge leakage, and due to this the decline in the developing performance becomes even more substantial. As a result, the generation of the image defect denoted as “fogging”, in which toner having a low charge quantity is developed into non-image regions on the photosensitive member, is facilitated.

As a countermeasure to this, Japanese Patent Application Laid-open No. 2019-219645 proposes a toner that combines a magnetic body of controlled surface hydrophobicity with a side-chain crystalline resin that has a crystalline segment and an amorphous segment.

However, while the toner described in Japanese Patent Application Laid-open No. 2019-219645 does have a certain effect with regard to improving the low-temperature fixability and suppressing fogging, it has been found that there is room for further improvement with regard to image durability. Due to the presence of hydroxyl groups at the magnetic body surface, there is a tendency for miscibilization with the highly hydrophobic side-chain crystalline resin to be inadequate. Due to this, magnetic bodies end up aggregating with each other when the binder resin, etc., melts upon the application of heat to the toner during fixing. When magnetic body aggregation occurs in the fixed image, it is thought that the area of the magnetic body aggregate/resin interface then becomes large and as a result cracking can occur with this as the starting point.

In view of the preceding, additional improvements are thus desired in order to realize a toner that exhibits an excellent low-temperature fixability, heat-resistant storability, and developing performance and that also exhibits an excellent image durability.

### SUMMARY OF THE INVENTION

The present disclosure provides a toner that exhibits an excellent low-temperature fixability, heat-resistant storability, and developing performance and that also exhibits an excellent image durability.

The present disclose relates to a magnetic toner comprising a toner particle, the toner particle comprising a magnetic body, a crystalline resin A, and an amorphous resin B, wherein the crystalline resin A comprises a monomer unit (a) represented by formula (a); the amorphous resin B comprises a monomer unit (b) represented by formula (b); a content of the crystalline resin A in the toner is 6.2 to 77.0 mass %; the sum of contents of the crystalline resin A and the amorphous resin B in the toner is 30.0 mass % or more; a content of the monomer unit (a) in the crystalline resin A is 50.0 to 100.0 mass %; and using SPA [(J/cm³)^{0.5}] for a SP value of the crystalline resin A and using SPB [(J/cm³)^{0.5}] for a SP value of the amorphous resin B, SPA and SPB satisfy 0.15≤SPB−SPA≤2.00:

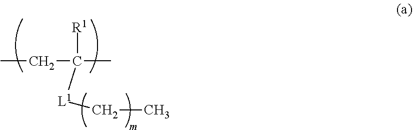

In the formula (a), R¹ represents a hydrogen atom or a methyl group, L¹ represents a single bond or a divalent linking group, and m represents an integer from 15 to 35:

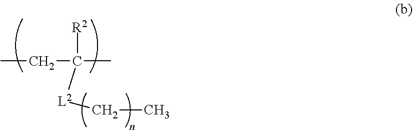

In the formula (b), R² represents a hydrogen atom or a methyl group, L² represents a single bond or a divalent linking group, and n represents an integer from 10 to 30.

The present disclosure can thereby provide a toner that exhibits an excellent low-temperature fixability, heat-resistant storability, and developing performance and that also exhibits an excellent image durability. Further features of the present disclosure will become apparent from the following description of exemplary embodiments.

### DESCRIPTION OF THE EMBODIMENTS

In the present disclosure, the wordings “from XX to YY” and “XX to YY” expressing numerical value ranges mean numerical value ranges including the lower limit and the upper limit as endpoints, unless otherwise stated. When numerical value ranges are described stepwise, upper limits and lower limits of those numerical value ranges can be combined suitably. The term “(meth)acrylic acid ester” means an acrylic acid ester and/or a methacrylic acid ester.

The term “monomer unit” refers to a reacted form of a monomer material included in a polymer. For example, a section including a carbon-carbon bond in a main chain of a polymer formed through polymerization of a polymerizable monomer will be referred to as a single unit. A polymerizable monomer can be represented by the following formula (C).

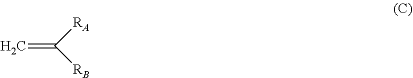

In the formula (C), R_{A} represents a hydrogen atom or an alkyl group (preferably, an alkyl group having 1 to 3 carbon atoms, and more preferably a methyl group), and R_{B} represents any substituent. The term “crystalline resin” refers to a resin that has a clear endothermic peak in differential scanning calorimetry (DSC).

With regard to magnetic toners that contain a magnetic body, a side-chain crystalline resin, and an amorphous resin, the present inventors discovered that the aforementioned disadvantage can be solved by introducing a monomer unit having a long-chain alkyl segment into both the side-chain crystalline resin and amorphous resin that constitute the toner, and by exercising, for these two species of resin, suitable control of the relationship between their SP values, their contents in the toner, and the amount of introduction of the long-chain alkyl segment.

The present disclose relates to a magnetic toner comprising a toner particle comprising a magnetic body, a crystalline resin A, and an amorphous resin B, wherein the crystalline resin A comprises a monomer unit (a) represented by a following formula (a); the amorphous resin B comprises a monomer unit (b) represented by a following formula (b); a content of the crystalline resin A in the toner is 6.2 to 77.0 mass %; the sum of contents of the crystalline resin A and the amorphous resin B in the toner is 30.0 mass % or more; a content of the monomer unit (a) in the crystalline resin A is 50.0 to 100.0 mass %; and using SPA [(J/cm³)^{0.5}] for a SP value of the crystalline resin A and using SPB [(J/cm³)^{0.5}] for a SP value of the amorphous resin B, SPA and SPB satisfy 0.15≤SPB−SPA≤2.00:

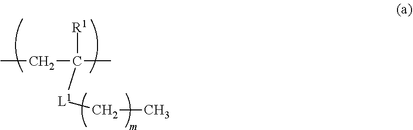

in the formula (a), R¹ represents a hydrogen atom or a methyl group, L¹ represents a single bond or a divalent linking group, and m represents an integer from 15 to 35:

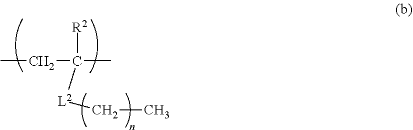

in the formula (b), R² represents a hydrogen atom or a methyl group, L² represents a single bond or a divalent linking group, and n represents an integer from 10 to 30.

The authors think the following with regard to the mechanisms by which the effects of the present disclosure are exhibited. The crystalline resin A in the present disclosure is a side-chain crystalline resin that comprises a monomer unit having a long-chain alkyl group in side chain position, and exhibits a sharp melt property. As a consequence, when the crystalline resin A is comprised in the toner particle, a sharp melt property is conferred on the toner and low-temperature fixability and heat-resistant storability are achieved.

On the other hand, the crystalline resin A has a high hydrophobicity because the crystalline resin A contains a large amount of a monomer unit having the long-chain alkyl group, but the magnitude of this hydrophobicity sets up a tendency for compatibility with the hydroxyl groups (also denoted as the hydrophilic moiety in the following) present at the magnetic body surface to be inadequate; magnetic body aggregation is then facilitated when the binder resin, etc. melts during fixing of the toner.

In the present disclosure, the amorphous resin B is comprised in the toner particle. Like the crystalline resin A, the amorphous resin B is also a resin that comprises a monomer unit having a long-chain alkyl group in side chain position, but its SP value is higher than that of the crystalline resin A. That is, the hydrophobicity of the amorphous resin B is lower than the hydrophobicity of the crystalline resin A. As a result, the amorphous resin B interacts more readily with the hydrophilic moiety of the magnetic body than does the crystalline resin A.

In the present disclosure, the SP value of the amorphous resin B also resides in a particular relationship with the SP value of the crystalline resin A. Because the toner particle contains an amorphous resin B of which a hydrophobicity is adjusted, an interaction between the amorphous resin B and the hydrophilic moiety of the magnetic body operates at the same time as a hydrophobic interaction between the monomer unit having long-chain alkyl group of the crystalline resin A and the monomer unit having alkyl group of the amorphous resin B. As a result, the amorphous resin B mediates between the crystalline resin A and the magnetic body, and as a consequence magnetic body aggregation can be suppressed and the image durability can be improved.

Moreover, an interface between the side-chain crystalline resin and the amorphous resin is inevitably present in each individual toner particle in toner that uses both a side-chain crystalline resin and an amorphous resin. A state exists at this interface in which the molecular chains of the side-chain crystalline resin are entangled with the molecular chains of the amorphous resin, and there is a tendency in this interface region for the crystallinity to be locally low. By having the long-chain alkyl group be present in side chain position in both the crystalline resin A and the amorphous resin B, the reduction in the crystallinity of the crystalline resin A at the interface of these resins can then be kept to a minimum. As a result, the effects associated with the crystalline resin A can be exhibited even though the toner particle contains the amorphous resin.

The toner according to the present disclosure, which exhibits an excellent low-temperature fixability, heat-resistant storability, and developing performance as well as an excellent image durability, is achieved through the mechanisms as described in the preceding.

The toner according to the present disclosure is particularly described in the following.

The toner particle comprises the crystalline resin A. A toner that exhibits an excellent low-temperature fixability, heat-resistant storability, and developing performance is provided, when the toner particle contains the crystalline resin A. The crystalline resin A comprises a monomer unit (a) represented by the following formula (a). As a consequence of this, the crystalline resin A is a side-chain crystalline resin.

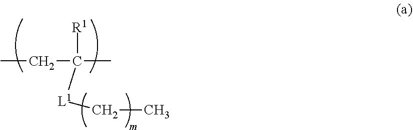

In formula (a), R¹ represents a hydrogen atom or a methyl group, L¹ represents a single bond or a divalent linking group, and m represents an integer from 15 to 35.

Formula (a) indicates that the crystalline resin A has a long-chain alkyl group, and the exhibition of crystallinity by the crystalline resin A is facilitated by the presence of the long-chain alkyl group as a side chain. When the m in formula (a) is less than 15, the crystallinity is prone to be inadequate and the image durability, heat-resistant storability, and developing performance decline. The m in formula (a) is preferably 15 to 30, more preferably 17 to 29, and even more preferably 19 to 23.

There are no particular limitations on the divalent linking group when the L¹ in formula (a) is a divalent linking group, but it can be exemplified by an amide group, an ester group, an urethane group, an urea group, an alkylene group, a phenylene group, the group represented by —O—, and the group represented by—NR—(R represents a hydrogen atom, an alkyl group, a phenyl group, or an aralkyl group). The divalent linking group is preferably an alkylene group, an amide group, or an ester group and is more preferably an ester group. When L¹ is a divalent linking group and this divalent linking group is an ester group, the monomer unit (a) is then the monomer unit (a-1) represented by the following formula (a-1).

An example of a method for introducing the monomer unit (a) into the crystalline resin A is the introduction into a vinyl polymerization of a monomer such as α-olefin and β-olefin having a long-chain alkyl group having 16 to 36 carbon atoms, (meth)acrylate ester having a long-chain alkyl group having 16 to 36 carbon atoms, N-alkylacrylamide having a long-chain alkyl group having 16 to 36 carbon atoms, and so forth.

Among monomer units (a), the monomer unit (a-1) represented by formula (a-1) is preferred for the ease of control of the SP value and the ease of control of the properties of the crystalline resin A, i.e., the melting point.

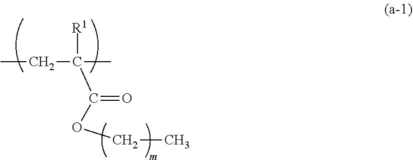

In formula (a-1), R¹ represents a hydrogen atom or a methyl group, and m represents an integer from 15 to 35 (preferably 15 to 30, more preferably 17 to 29, and still more preferably 19 to 23).

An example of a method for introducing the monomer unit (a-1) represented by formula (a-1) is the introduction into a vinyl polymerization of a (meth)acrylate ester as shown in the following examples.

The following monomers are examples: (meth)acrylate esters having a linear alkyl group having 16 to 36 carbon atoms [e.g., stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate, and dotriacontyl (meth)acrylate] and (meth)acrylate esters having a branched alkyl group having 18 to 36 carbon atoms [e.g., 2-decyltetradecyl (meth)acrylate].

A single monomer that forms the monomer unit (a) may be used by itself or two or more may be used in combination, and a single monomer that forms the monomer unit (a-1) may be used by itself or two or more may be used in combination.

The crystalline resin A may also contain another monomer unit besides the monomer unit (a). An example of a method for introducing this additional monomer unit is to carry out polymerization of another vinyl monomer with monomer as provided above as examples.

### Examples of the Other Vinyl Monomer Include the Followings

(Meth)acrylic acid esters such as styrene, α-methylstyrene, methyl (meth)acrylate, ethyl (meth)acrylate, n-butyl (meth)acrylate, t-butyl (meth)acrylate, and 2-ethylhexyl (meth)acrylate.

Monomers that have a urea group, such as monomers obtained by causing a reaction between an amine having 3 to 22 carbon atoms [e.g., a primary amine (normal-butylamine, t-butylamine, propylamine, isopropylamine, etc.), a secondary amine (di-normal-ethylamine, di-normal-propylamine, di-nromal-butylamine, etc.), aniline, cycloxyl amine, etc.] and an isocyanate that has an ethylenically unsaturated bond and 2 to 30 carbon atoms, by using a known method.

Monomers that have a carboxy group, such as methacrylic acid, acrylic acid, and 2-carboxyethyl (meth)acrylate.

Monomers that have a hydroxy group, such as 2-hydroxyethyl (meth)acrylate and 2-hydroxypropyl (meth)acrylate.

Monomers that have an amide group, such as acrylamides and monomers obtained by causing a reaction between an amine having 1 to 30 carbon atoms and a carboxylic acid (acrylic acid, methacrylic acid, etc.) that has an ethylenically unsaturated bond and 2 to 30 caron atoms, by using a known method.

Monomers that have a nitrile group, such as acrylonitrile and methacrylonitrile.

Monomers that have a urethane group: for example, monomers provided by the reaction by a known method of an alcohol having 2 to 22 carbon atoms and an ethylenically unsaturated bond (e.g., 2-hydroxyethyl methacrylate and vinyl alcohol) with an isocyanate having 1 to 30 carbon atoms [e.g., monoisocyanate compounds (e.g., benzenesulfonyl isocyanate, tosyl isocyanate, phenyl isocyanate, p-chlorophenyl isocyanate, butyl isocyanate, hexyl isocyanate, t-butyl isocyanate, cyclohexyl isocyanate, octyl isocyanate, 2-ethylhexyl isocyanate, dodecyl isocyanate, adamantyl isocyanate, 2,6-dimethylphenyl isocyanate, 3,5-dimethylphenyl isocyanate, and 2,6-dipropylphenyl isocyanate), aliphatic diisocyanate compounds (e.g., trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, and 2,4,4-trimethylhexamethylene diisocyanate), alicyclic diisocyanate compounds (e.g., 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, and hydrogenated tetramethylxylylene diisocyanate), and aromatic diisocyanate compounds (e.g., phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, and xylylene diisocyanate)], and monomers provided by the reaction by a known method between an alcohol having 1 to 26 carbon atoms (e.g., methanol, ethanol, propanol, isopropyl alcohol, butanol, t-butyl alcohol, pentanol, heptanol, octanol, 2-ethylhexanol, nonanol, decanol, undecyl alcohol, lauryl alcohol, dodecyl alcohol, myristyl alcohol, pentadecyl alcohol, cetanol, heptadecanol, stearyl alcohol, isostearyl alcohol, elaidyl alcohol, oleyl alcohol, linoleyl alcohol, linolenyl alcohol, nonadecyl alcohol, heneicosanol, behenyl alcohol, erucyl alcohol) and an isocyanate having 2 to 30 carbon atoms and containing an ethylenically unsaturated bond [e.g., 2-isocyanatoethyl (meth)acrylate, 2-(O-[1′-methylpropylideneamino]carboxyamino)ethyl (meth)acrylate, 2-[(3,5-dimethylpyrazolyl)carbonylamino]ethyl (meth)acrylate, and 1,1-(bis(meth)acryloyloxymethyl)ethyl isocyanate].

Vinyl esters: vinyl acetate, vinyl propionate, vinyl butyrate, vinyl caproate, vinyl caprylate, vinyl caprate, vinyl laurate, vinyl myristate, vinyl palmitate, vinyl stearate, vinyl pivalate, vinyl octylate. Among the preceding, the use is preferred of styrene, methacrylic acid, acrylic acid, methyl (meth)acrylate, and t-butyl (meth)acrylate.

The content of the monomer unit (a) in the crystalline resin A is 50.0 to 100.0 mass %. When the monomer unit (a) content is less than 50.0 mass %, exhibition of the sharp melt property of the crystalline resin A itself is impeded and the low-temperature fixability is impaired. The lower limit is more preferably 60.0 mass % or more, even more preferably 65.0 mass % or more, and still more preferably 70.0 mass % or more. Viewed from the standpoint of the low-temperature fixability, the upper limit is more preferably 95.0 mass % or less, still more preferably 90.0 mass % or less, and even more preferably 85.0 mass % or less. The following, for example, are preferred: 50.0 to 90.0 mass %, 60.0 to 95.0 mass %, 65.0 to 90.0 mass %, and 70.0 to 85.0 mass %.

The content of the monomer unit (a) in the crystalline resin A can be adjusted by changing the amount of monomer that forms the monomer unit (a). When two or more species of monomer unit (a) are present in the crystalline resin A, the content of the monomer unit (a) is then their sum.

The crystalline resin A preferably comprises a monomer unit derived from a styrene represented by the following formula (A). In addition, the crystalline resin A preferably comprises a monomer unit derived from the (meth)acrylic acid represented by the following formula (B). The crystalline resin A may comprise the monomer unit derived from (meth)acrylonitrile represented by the following formula (C).

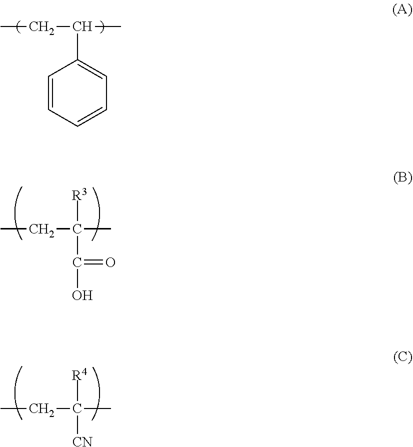

The R³ in formula (B) represents a hydrogen atom or methyl group. R³ is preferably a methyl group. The R⁴ in formula (C) represents a hydrogen atom or methyl group. R⁴ is preferably a methyl group.

The content of the monomer unit derived from a styrene in the crystalline resin A is preferably 1.0 to 50.0 mass %, more preferably 3.0 to 46.0 mass %, still more preferably 10.0 to 30.0 mass %, and particularly preferably 15.0 to 27.0 mass %. The content of the monomer unit derived from (meth)acrylic acid (preferably methacrylic acid) in the crystalline resin A is preferably 1.0 to 5.0 mass %, more preferably 1.0 to 3.0 mass %, and still more preferably 1.5 to 2.5 mass %. The content of the monomer unit derived from a (meth)acrylonitrile (preferably methacrylonitrile) in the crystalline resin A is preferably 1.0 to 30.0 mass %, more preferably 5.0 to 25.0 mass %, and still more preferably 10.0 to 20.0 mass %.

The content of the crystalline resin A in the toner is 6.2 to 77.0 mass %. When the crystalline resin A content is less than 6.2 mass %, the toner is inadequately endowed with the sharp melt property and the low-temperature fixability and heat-resistant storability decline. When the crystalline resin A content is greater than 77.0 mass %, the low electrical resistance becomes prominent and the developing performance declines.

From a similar perspective, the lower limit is preferably 6.8 mass % or more, more preferably 10.0 mass % or more, and still more preferably 15.0 mass % or more, while the upper limit is preferably 70.6 mass % or less, more preferably 60.0 mass % or less, still more preferably 50.0 mass % or less, and even more preferably 40.0 mass % or less. The following, for example, are preferred: 6.8 to 70.6 mass %, 10.0 to 60.0 mass %, 15.0 to 50.0 mass %, and 10.0 to 40.0 mass %.

The toner particle comprises an amorphous resin B in addition to the crystalline resin A. When the toner particle comprises the amorphous resin B, the amorphous resin B can mediate between the crystalline resin A and the magnetic body and magnetic body aggregation can be suppressed, and as a result a toner having an excellent image durability is provided.

The amorphous resin B comprises a monomer unit (b) represented by the following formula (b).

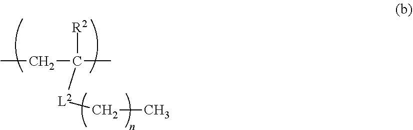

In formula (b), R² represents a hydrogen atom or a methyl group, L² represents a single bond or a divalent linking group, and n represents an integer from 10 to 30.

As described above, it is thought that, through the presence of the monomer unit (b) in the amorphous resin B, reductions in the crystallinity of the resin A are kept to a minimum and magnetic body aggregation is suppressed and as a consequence the low-temperature fixability can co-exist with the image durability at high levels for both.

From the standpoint of keeping reductions in the crystallinity of the crystalline resin A to a minimum, n is preferably in the range of 10 to 29, more preferably 10 to 19, still more preferably 10 to 15, even more preferably 10 to 14, and particularly preferably 10 to 13.

The resin exhibits an amorphous character, and the amorphous resin B can thus be provided, by having the resin which comprises the monomer unit (b) represented by formula (b) and having n be in the indicated range. Adjusting the content of the monomer unit (b), infra, is also effective for adjusting the amorphous character of the resin.

When the L² in formula (b) is a divalent linking group, there are no particular limitations on this divalent linking group, but the same divalent linking groups as for the L¹ in formula (a) can preferably be used. When L² is a divalent linking group and this divalent linking group is an ester group, the monomer unit (b) is then the monomer unit (b-1) represented by the following formula (b-1).

An example of a method for introducing the monomer unit (b) into the amorphous resin B is the introduction into a vinyl polymerization of a monomer such as α-olefin and β-olefin having a long-chain alkyl group having 11 to 31 carbon atoms, (meth)acrylate ester having a long-chain alkyl group having 11 to 31 carbon atoms, N-alkylacrylamide having a long-chain alkyl group having 11 to 31 carbon atoms, and so forth.

Among monomer units (b), the monomer unit (b-1) represented by formula (b-1) is preferred for the ease of control of the SP value and the ease of control of the properties of the amorphous resin B, i.e., the melting point.

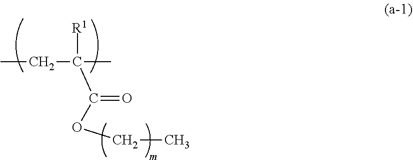

In formula (b-1), R² represents a hydrogen atom or a methyl group, and n represents an integer from 10 to 30 (preferably 10 to 29, more preferably 10 to 19, still more preferably 10 to 15, even more preferably 10 to 14, and particularly preferably 10 to 13).

A (meth)acrylate ester having a linear alkyl group having 11 to 31 carbon atoms may be used as monomer as a method for introducing the monomer unit (b-1) represented by the formula (b-1). For example, monomer that forms the monomer unit (b-1) as indicated in the following may be used in addition to monomer that can be used for the monomer unit (a-1) as described above. Examples here are octyl (meth)acrylate, decyl (meth)acrylate, lauryl (meth)acrylate, myristyl (meth)acrylate, and palmityl (meth)acrylate. A single monomer that forms the monomer unit (b) may be used by itself or two or more may be used in combination, and a single monomer that forms the monomer unit (b-1) may be used by itself or two or more may be used in combination.

The amorphous resin B may also have another monomer unit besides the monomer unit (b). An example of a method for introducing this additional unit is the execution of polymerization between monomer that forms monomer unit (b) and a vinyl monomer that can be used for the crystalline resin A as described above.

The amorphous resin B preferably comprises at least one monomer unit Y selected from the group consisting of a monomer unit derived from a styrene represented by the following formula (D) and a monomer unit derived from an alkyl (meth)acrylate ester represented by the following formula (E). The amorphous resin B may comprise a monomer unit derived from (meth)acrylonitrile represented by the following formula (F).

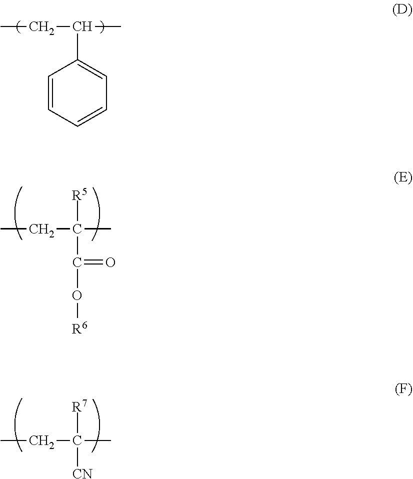

In formula (E), R⁵ represents a hydrogen atom or methyl group and R⁶ represents an alkyl group having 1 to 8 (preferably 1 to 6 and more preferably 1 to 4) carbon atoms. R⁵ is preferably a methyl group. The R⁷ in formula (F) represents a hydrogen atom or methyl group. R⁷ is preferably a methyl group.

The content of the monomer unit (b) in the amorphous resin B is preferably 2.7 to 47.0 mass %. Compliance with this range facilitates the occurrence of a lower hydrophobicity for the amorphous resin B than for the crystalline resin A. As a result, a large effect is provided from the mediation by the amorphous resin B between the crystalline resin A and the magnetic body and magnetic body aggregation can be further suppressed and the image durability can be enhanced.

The lower limit for the content of the monomer unit (b) is preferably 3.0 mass % or more, more preferably 5.0 mass % or more, still more preferably 10.0 mass % or more, particularly preferably 15.0 mass % or more, and even more preferably 20.0 mass % or more. The upper limit is preferably 43.0 mass % or less, more preferably 40.0 mass % or less, still more preferably 35.0 mass % or less, and particularly preferably 30.0 mass % or less. The following, for example, are preferred: 3.0 to 43.0 mass %, 5.0 to 40.0 mass %, 10.0 to 35.0 mass %, 15.0 to 30.0 mass %, and 20.0 to 30.0 mass %.

When the content of the monomer unit (b) is in the above range, the resin tends to exhibit amorphous character, and the amorphous resin B tends to be provided. In addition, the low-temperature fixability, heat-resistant storability, and developing performance will co-exist with the image durability at high levels for all. The content of the monomer unit (b) in the amorphous resin B can be adjusted by changing the amount of monomer that forms the monomer unit (b).

The content in the amorphous resin B of the at least one monomer unit Y selected from the group consisting of the monomer unit derived from a styrene represented by formula (D) and the monomer unit derived from an alkyl (meth)acrylate ester represented by formula (E) is preferably 50.0 to 97.0 mass %, more preferably 60.0 to 90.0 mass %, still more preferably 65.0 to 85.0 mass %, and even more preferably 70.0 to 80.0 mass %. The content of the monomer unit derived from a (meth)acrylonitrile (preferably methacrylonitrile) in the amorphous resin B is preferably 1.0 to 30.0 mass %, more preferably 5.0 to 25.0 mass %, and still more preferably 10.0 to 20.0 mass %.

The content of the amorphous resin B in the toner is preferably 2.7 to 63.0 mass %, more preferably 2.9 to 58.8 mass %, still more preferably 11.0 to 55.0 mass %, even more preferably 20.0 to 55.0 mass %, and particularly preferably 25.0 to 45.0 mass %. By having the amorphous resin B content be in the indicated range, the low-temperature fixability, image durability, and developing performance can all co-exist at high levels for each.

The sum of contents of the crystalline resin A and the amorphous resin B in the toner is 30.0 mass % or more. The sum of the contents of the crystalline resin A and the amorphous resin B in the toner is preferably 30.0 to 95.0 mass %, more preferably 34.1 to 73.5 mass %, and still more preferably 45.0 to 62.0 mass %. By having the sum of the contents of the crystalline resin A and the amorphous resin B be in the above range, the low-temperature fixability, heat-resistant storability, and developing performance can be made to co-exist with the image durability, all at high levels.

The glass transition temperature Tg of the amorphous resin B is preferably 30.0° C. to 90.0° C. When the amorphous resin B exhibits a Tg, this indicates that the amorphous resin B is an amorphous resin that resides in a glassy state in the normal temperature region, and the image durability is improved by this. In addition, the Tg is preferably in the indicated range from the standpoints of the low-temperature fixability and heat-resistant storability. The glass transition temperature Tg of the amorphous resin B can be adjusted by altering the composition of the amorphous resin B.

Using SPA [(J/cm³)^{0.5}] for a SP value of the crystalline resin A and using SPB [(J/cm³)^{0.5}] for a SP value of the amorphous resin B, SPA and SPB satisfy 0.15≤SPB−SPA≤2.00. The SP value, also referred to as the solubility parameter, is a numerical value used as an index of affinity or solubility; it shows to what extent a particular substance dissolves in a particular substance. When two solubility parameters are near each other, the solubility or affinity is higher; when the solubility parameters are separated, the solubility or affinity is lower.

SPB−SPA indicates the difference between the SP values of the crystalline resin A and the amorphous resin B, i.e., indicates the magnitude of the affinity between the crystalline resin A and the amorphous resin B. When SPB−SPA is less than 0.15, the compatibility between the two is too good and they undergo compatibilization as a consequence and the crystallinity of the crystalline resin A ends up declining; a satisfactory heat-resistant storability and developing performance are not exhibited as a result.

When SPB−SPA is larger than 2.00, the compatibility between the two is poor and the crystalline resin A, which is a side-chain crystalline resin, forms large domains and is prone to be present as such, and due to this the dispersion of the magnetic body is reduced and the low-temperature fixability and image durability are not adequately improved as a consequence. SPB−SPA is preferably 0.20≤SPB−SPA≤1.60, more preferably 0.60≤SPB−SPA≤1.30, and still more preferably 0.80≤SPB−SPA≤1.20. SPA and SPB can be controlled by changes in the composition of the crystalline resin A and the composition of the amorphous resin B.

There is no particular limitation on the SPA of the crystalline resin as long as SPA and SPB reside in the above relationship, but SPA is preferably 17.00 to 20.00, more preferably 17.50 to 19.50, still more preferably 18.00 to 19.00, and particularly preferably 18.20 to 18.80.

In addition to the crystalline resin A and amorphous resin B, the toner may contain another resin component in pursuit of various objectives. Examples of usable resins are vinyl resins that do not correspond to crystalline resin A or amorphous resin B, a polyester, a polyurethane, and an epoxy resin, with a polyester being preferred. For example, the crystalline resin A, amorphous resin B, and another resin may be binder resins. Polymerizable monomer that forms a vinyl resin that does not correspond to the crystalline resin A or amorphous resin B can be exemplified by polymerizable monomers, among those already provided above, other than polymerizable monomers that form the monomer unit (a) or monomer unit (b). A combination of two or more may be used as necessary.

The polyester can be obtained by the condensation polymerization reaction of an at least dibasic polybasic carboxylic acid with a polyhydric alcohol. The polycarboxylic acid can be exemplified by the following compounds: dibasic acids, e.g., succinic acid, adipic acid, sebacic acid, phthalic acid, isophthalic acid, terephthalic acid, malonic acid, and dodecenylsuccinic acid and their anhydrides and lower alkyl esters; aliphatic unsaturated dicarboxylic acids, e.g., maleic acid, fumaric acid, itaconic acid, and citraconic acid; and 1,2,4-benzenetricarboxylic acid (trimellitic acid) and 1,2,5-benzenetricarboxylic acid and their anhydrides and lower alkyl esters. Terephthalic acid, isophthalic acid, and trimellitic anhydride are preferred. A single one of these may be used by itself or two or more may be used in combination.

The polyhydric alcohol can be exemplified by the following compounds: alkylene glycols (ethylene glycol, 1,2-propylene glycol, and 1,3-propylene glycol), alkylene ether glycols (polyethylene glycol and polypropylene glycol), alicyclic diols (1,4-cyclohexanedimethanol), bisphenols (bisphenol A), alkylene oxide (ethylene oxide or propylene oxide) adducts on alicyclic diols; and alkylene oxide (ethylene oxide or propylene oxide) adducts on bisphenols, such as the adduct of 2 moles propylene oxide on bisphenol A. The alkyl moiety of the alkylene glycol and alkylene ether glycol may be straight chain or branched. The alkylene oxide adducts on bisphenols are preferred, and the adduct of 2 moles propylene oxide on bisphenol A is more preferred.

Alkylene glycols having a branched structure can also be preferably used. Examples in this regard are glycerol, trimethylolethane, trimethylolpropane, and pentaerythritol. A single one of these may be used by itself or two or more may be used in combination.

As necessary, a monobasic acid such as acetic acid or benzoic acid and a monohydric alcohol such as cyclohexanol or benzyl alcohol may also be used for the purpose of adjusting the acid value or hydroxyl value. The method for producing the polyester is not particularly limited and can be exemplified by ester exchange methods and direct polycondensation methods.

The polyurethane is obtained by the reaction of a diol component and a diisocyanate component. The diisocyanate component can be exemplified by the following: aromatic diisocyanates having from 6 to 20 carbon atoms (excluding the carbon in the NCO group, the same applies in the following), aliphatic diisocyanates having from 2 to 18 carbon atoms, and alicyclic diisocyanates having from 4 to 15 carbon atoms, as well as modifications of these diisocyanates (modifications that contain the urethane group, carbodiimide group, allophanate group, urea group, biuret group, uretdione group, uretoimine group, isocyanurate group, or oxazolidone group, also referred to herebelow as “modified diisocyanate”) and mixtures of two or more of the preceding.

The following are examples of the aromatic diisocyanates: m- and/or p-xylylene diisocyanate (XDI) and α,α,α′,α′-tetramethylxylylene diisocyanate. The following are examples of the aliphatic diisocyanates: ethylene diisocyanate, tetramethylene diisocyanate, hexamethylene diisocyanate (HDI), and dodecamethylene diisocyanate. The following are examples of the alicyclic diisocyanates: isophorone diisocyanate (IPDI), dicyclohexylmethane-4,4′-diisocyanate, cyclohexylene diisocyanate, and methylcyclohexylene diisocyanate.

Preferred among the preceding are aromatic diisocyanates having from 6 to 15 carbon atoms, aliphatic diisocyanates having from 4 to 12 carbon atoms, and alicyclic diisocyanates having from 4 to 15 carbon atoms, wherein XDI, IPDI, and HDI are particularly preferred. A trifunctional or higher functional isocyanate compound may also be used in addition to the diisocyanate component. The same dihydric alcohols usable for the polyester as described above can be adopted for the diol component that can be used for the polyurethane.

The weight-average molecular weight (Mw) of the tetrahydrofuran (THF)-soluble matter of the toner, as measured by gel permeation chromatography (GPC), is preferably 10,000 to 200,000. The lower limit is more preferably 30,000 or more, still more preferably 50,000 or more, even more preferably 80,000 or more, and particularly preferably 90,000 or more. The upper limit is more preferably 180,000 or less, still more preferably 150,000 or less, even more preferably 130,000 or less, and particularly preferably 120,000 or less. Examples are 30,000 to 180,000, 50,000 to 150,000, 80,000 to 130,000, and 90,000 to 120,000. Obtaining low-temperature fixability for the toner is facilitated by having Mw be in the above range.

The toner may contain a release agent. The release agent is preferably at least one selected from the group consisting of a hydrocarbon wax and an ester wax. Use of a hydrocarbon wax and/or an ester wax makes it easy to achieve effective releasability.

The hydrocarbon wax is not particularly limited, but examples thereof are as follows. Aliphatic hydrocarbon waxes: low molecular weight polyethylene, low molecular weight polypropylene, low molecular weight olefin copolymers, Fischer Tropsch waxes, and waxes obtained by subjecting these to oxidation or acid addition.

The ester wax should have at least one ester bond per molecule, and may be a natural ester wax or a synthetic ester wax. Ester waxes are not particularly limited, but examples thereof are as follows: Esters of a monohydric alcohol and a monocarboxylic acid, such as behenyl behenate, stearyl stearate and palmityl palmitate; Esters of a dicarboxylic acid and a monoalcohol, such as dibehenyl sebacate; Esters of a dihydric alcohol and a monocarboxylic acid, such as ethylene glycol distearate and hexane diol dibehenate; Esters of a trihydric alcohol and a monocarboxylic acid, such as glycerol tribehenate; Esters of a tetrahydric alcohol and a monocarboxylic acid, such as pentaerythritol tetrastearate and pentaerythritol tetrapalmitate; Esters of a hexahydric alcohol and a monocarboxylic acid, such as dipentaerythritol hexastearate, dipentaerythritol hexapalmitate and dipentaerythritol hexabehenate; Esters of a polyfunctional alcohol and a monocarboxylic acid, such as polyglycerol behenate; and natural ester waxes such as carnauba wax and rice wax.

Of these, esters of a hexahydric alcohol and a monocarboxylic acid, such as dipentaerythritol hexastearate, dipentaerythritol hexapalmitate and dipentaerythritol hexabehenate, are preferred.

The release agent may be a hydrocarbon-based wax or an ester wax in isolation, a combination of a hydrocarbon-based wax and an ester wax, or a mixture of two or more types of each, but it is preferable to use a hydrocarbon-based wax in isolation or two or more types thereof. It is more preferable for the release agent to be a hydrocarbon wax.

In the toner, the release agent has a content of preferably from 1.0 mass % to 30.0 mass %, or more preferably from 2.0 mass % to 25.0 mass % in the toner particle. If the content of the release agent in the toner particle is within this range, the release properties are easier to secure during fixing. The melting point of the release agent is preferably from 60° C. to 120° C. If the melting point of the release agent is within this range, it is more easily melted and exuded on the toner particle surface during fixing, and is more likely to provide release effects. The melting point is more preferably from 70° C. to 100° C.

The toner particle comprises a magnetic body. The magnetic body used in the magnetic toner can be exemplified by magnetic iron oxides such as magnetite, maghemite, ferrite, and magnetic iron oxides that contain another metal oxide; and metals such as Fe, Co, and Ni and alloys of these metals with a metal such as A1, Co, Cu, Pb, Mg, Ni, Sn, Zn, Sb, Be, Bi, Cd, Ca, Mn, Se, Ti, W, and V, and/or with the oxides of these metals; and mixtures of the preceding. Magnetite is preferably used among these magnetic bodies.

The shape of the magnetic body may be, for example, polyhedral, octahedral, hexahedral, spherical, acicular, flake, and so forth. Among these shapes, low-anisotropy shapes, e.g., polyhedral, octahedral, hexahedral, and spherical, are preferred from the standpoint of increasing the image density.

The volume-average particle diameter of the magnetic body is preferably 0.10 to 0.40 μm. When the volume-average particle diameter is at least 0.10 μm, the magnetic body is then resistant to aggregation and the ability of the magnetic body to uniformly disperse in the toner particle is improved. The tinting strength of the toner is enhanced when the volume-average particle diameter is not more than 0.40 μm.

The volume-average particle diameter of the magnetic body can be measured using a transmission electron microscope. Specifically, the toner is thoroughly dispersed in an epoxy resin and a cured material is obtained by curing for 2 days in an atmosphere with a temperature of 40° C. Thin-section samples of this cured material are made using a microtome, and the particle diameter is measured on 100 magnetic bodies in the visual field of an image obtained using a transmission electron microscope (TEM) at a magnification of 10,000× to 40,000×. In addition, the projected area of the magnetic body is measured, the radius is calculated for the circle having an area equal to this projected area, and the approximate volume of the magnetic body is calculated by calculating the volume of the sphere having this radius. The volume-average particle diameter is calculated from these results. The volume-average particle diameter of the magnetic body may also be measured using an image analysis instrument.

The content of the magnetic body in the toner is preferably 5.0 to 50.0 mass %, more preferably 7.0 to 45.0 mass %, and still more preferably 15.0 to 40.0 mass %. Having the magnetic body be in the indicated range facilitates co-existence between the low-temperature fixability and the image durability and developing performance at high levels for each.

The magnetic body used in the toner can be produced, for example, using the following method. An alkali, e.g., sodium hydroxide, is added in an equivalent amount or at least an equivalent amount with reference to the iron component to an aqueous solution of a ferrous salt to prepare an aqueous solution containing ferrous hydroxide. Air is blown in while keeping the pH of the prepared aqueous solution at 7 or above, and an oxidation reaction is carried out on the ferrous hydroxide while heating the aqueous solution to at least 70° C. to first produce seed crystals that will form the magnetic body core.

An aqueous solution containing ferrous sulfate is then added, at 1 equivalent based on the amount of addition of the previously added alkali, to the seed crystal-containing slurry. While maintaining the pH of the liquid at 5 to 10 and blowing in air, the reaction of the ferrous hydroxide is developed in order to grow magnetic iron oxide particles using the seed crystals as cores. At this point, the shape and magnetic properties of the magnetic body can be controlled by adjusting the pH, reaction temperature, and stirring conditions. The pH of the liquid transitions to the acidic side as the oxidation reaction progresses, but the pH of the liquid preferably does not drop below 5. The thusly obtained magnetic iron oxide particles can be filtered, washed, and dried to obtain the magnetic body.

In addition, when the toner particle is produced by a polymerization method, the magnetic body surface is preferably subjected to a hydrophobic treatment. The hydrophobic treatment method is not particularly limited, but can be exemplified by treatment with a coupling agent. When the hydrophobic treatment is performed by a dry method, the magnetic body surface can be subjected to a hydrophobic treatment by carrying out treatment with the coupling agent on the surface of the magnetic body that has been washed, filtered, and dried.

When the hydrophobic treatment is carried out by a wet method, after the completion of the oxidation reaction, the dried material may be redispersed and treatment with the coupling agent may be carried out; or, after the completion of the oxidation reaction, the iron oxide provided by washing and filtration may be redispersed without drying in another aqueous medium and treatment with the coupling agent may then be carried out.

When a redispersion is performed, the coupling agent treatment can be specifically carried out as follows: the silane coupling agent is added while stirring the iron oxide redispersion and, after hydrolysis, the temperature is raised, or, after hydrolysis, the pH of the redispersion is adjusted into the alkaline region.

Among the preceding, and considered from the standpoint of performing the hydrophobic treatment uniformly on the magnetic body surface, preferably the completion of the oxidation reaction is followed by filtration and washing and then, without drying, conversion directly into a slurry and execution of the hydrophobic treatment.

The following is an example of a method for carrying out hydrophobic treatment of the magnetic body by a wet method. First, the magnetic body is dispersed in an aqueous medium so as to generate the primary particles, and stirring is performed with, e.g., a stirring blade, so as to prevent sedimentation and aggregation. The appropriate amount of the coupling agent is then introduced into this dispersion, and treatment with the coupling agent is performed while carrying out hydrolysis of the coupling agent. During this, treatment with the coupling agent is preferably carried out while stirring and also while carrying out dispersion, using a device such as a pin mill or line mill, to avoid aggregation. The aqueous medium is a medium for which water is the main component. Examples are water itself, a medium provided by the addition of a small amount of surfactant to water, a medium provided by the addition of a pH adjustment agent to water, and a medium provided by the addition of an organic solvent to water.

The surfactant is preferably a nonionic surfactant such as polyvinyl alcohol. The surfactant is preferably added so as to provide a concentration of 0.1 to 5.0 mass % in the aqueous medium. The pH adjustment agent can be exemplified by inorganic acids, e.g., hydrochloric acid. The organic solvent can be exemplified by alcohols.

Coupling agents that can be used in the hydrophobic treatment of the magnetic body surface can be exemplified by silane coupling agents and titanium coupling agents. Silane coupling agents are preferred therebetween, and silane coupling agents represented by the following formula (G) are more preferred.

Rₘ—Si—Yₙ (G)

In formula (G), R represents an alkoxy group (preferably an alkoxy group having 1 to 3 carbon atoms) and m represents an integer from 1 to 3. Y represents an alkyl group (preferably an alkyl group having 2 to 20 carbon atoms), phenyl group, vinyl group, epoxy group, acrylic group, or methacrylic group. m and n each independently represent an integer from 1 to 3. However, m and n satisfy m+n=4.

The following are examples of the silane coupling agent represented by formula (G): vinyltrimethoxysilane, vinyltriethoxysilane, vinyltris(p-methoxyethoxy)silane, 0-(3,4-epoxycyclohexyl)ethyltrimethoxysilane, 7-glycidoxypropyltrimethoxysilane, 7-glycidoxypropylmethyldiethoxysilane, 7-aminopropyltriethoxysilane, N-phenyl-7-aminopropyltrimethoxysilane, 7-methacryloxypropyltrimethoxysilane, vinyltriacetoxysilane, methyltrimethoxysilane, dimethyldimethoxysilane, phenyltrimethoxysilane, diphenyldimethoxysilane, methyltriethoxysilane, dimethyldiethoxysilane, phenyltriethoxysilane, diphenyldiethoxysilane, n-butyltrimethoxysilane, isobutyltrimethoxysilane, trimethylmethoxysilane, n-hexyltrimethoxysilane, n-octyltrimethoxysilane, n-octyltriethoxysilane, n-decyltrimethoxysilane, hydroxypropyltrimethoxysilane, n-hexadexyltrimethoxysilane, and n-octadecyltrimethoxysilane.

Considered from the standpoint of providing the magnetic body with a high hydrophobicity, the use is preferred among the preceding of alkyltrialkoxysilane coupling agents represented by the following formula (H).

CₚH₂₉₊₁—Si—(OC_{q}H_{2q+1})₃ (H)

In formula (H), p represents an integer from 2 to 20 and q represents an integer from 1 to 3.

Hydrophobicity can be satisfactorily imparted to the magnetic body when p in the formula (H) is at least 2. Magnetic body-to-magnetic body coalescence can be suppressed when p is not more than 20. When q is not more than 3, the silane coupling agent has a good reactivity and hydrophobicity can be satisfactorily imparted to the magnetic body. The p in formula (H) is preferably an integer from 3 to 15 and q is preferably 1 or 2.

When a hydrophobic treatment agent, e.g., a silane coupling agent, is used, treatment may be carried out using a single species or treatment may be carried out using a combination of two or more species. When two or more species are used in combination, treatment may be carried out using each of the hydrophobic treatment agents separately or a simultaneous treatment may be carried out. The total amount of coupling agent used is preferably 0.9 mass parts to 3.0 mass parts relative to 100 mass parts of the magnetic body, and preferably the amount of coupling agent is adjusted in correspondence to, e.g., the surface area of the magnetic body, the reactivity of the coupling agent, and so forth.

The toner may also contain a colorant. Examples of colorants include known organic pigments, organic dyes, inorganic pigments, and carbon black and magnetic particles as black colorants. Other colorants conventionally used in toners may also be used. Examples of yellow colorants include condensed azo compounds, isoindolinone compounds, anthraquinone compounds, azo metal complexes, methine compounds and allylamide compounds. Specifically, C.I. pigment yellow 12, 13, 14, 15, 17, 62, 74, 83, 93, 94, 95, 109, 110, 111, 128, 129, 147, 155, 168 and 180 can be used by preference.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds and perylene compounds. Specifically, C.I. pigment red 2, 3, 5, 6, 7, 23, 48:2, 48:3, 48:4, 57:1, 81:1, 122, 144, 146, 166, 169, 177, 184, 185, 202, 206, 220, 221 and 254 can be used by preference. Examples of cyan colorants include copper phthalocyanine compounds and their derivatives, anthraquinone compounds, and basic dye lake compounds. Specifically, C.I. pigment blue 1, 7, 15, 15:1, 15:2, 15:3, 15:4, 60, 62 and 66 can be used by preference.

The colorants are selected based on considerations of hue angle, chroma, lightness, weather resistance, OHP transparency, and dispersibility in the toner. The content of the colorant is preferably from 1.0 to 20.0 mass parts per 100.0 mass parts of the binder resin.

A charge control agent may be included in the toner particle as necessary. A charge control agent may also be added externally to the toner particle. By compound a charge control agent, it is possible to stabilize the charging properties and control the triboelectric charge quantity at a level appropriate to the developing system. A known charge control agent may be used, and a charge control agent capable of providing a rapid charging speed and stably maintaining a uniform charge quantity is especially desirable.

Organic metal compounds and chelate compounds are effective as charge control agents for giving the toner a negative charge, and examples include monoazo metal compounds, acetylacetone metal compounds, and metal compounds using aromatic oxycarboxylic acids, aromatic dicarboxylic acids, oxycarboxylic acids and dicarboxylic acids. Examples of charge control agents for giving the toner a positive charge include nigrosin, quaternary ammonium salts, metal salts of higher fatty acids, diorganotin borates, guanidine compounds and imidazole compounds. The content of the charge control agent is preferably from 0.01 to 20.0 mass parts, or more preferably from 0.5 to 10.0 mass parts per 100.0 mass parts of the toner particle.

The toner particle may be used as—is as a toner, but a toner may, if necessary, also be formed by mixing an external additive or the like so as to attach the external additive to the surface of the toner particle. Examples of the external additive include inorganic fine particles selected from the group consisting of silica fine particles, alumina fine particles and titania fine particles, and composite oxides of these. Examples of composite oxides include silica-aluminum fine particles and strontium titanate fine particles. The content of the external additive is preferably from 0.01 parts by mass to 8.0 parts by mass, and more preferably from 0.1 parts by mass to 4.0 parts by mass, relative to 100 parts by mass of the toner particle.

Within the scope of the present configuration, the toner particle may be manufactured by any known conventional method such as suspension polymerization, emulsion aggregation, dissolution suspension or pulverization, but is preferably manufactured by a suspension polymerization method.

The following describes the suspension polymerization method in detail. A polymerizable monomer composition is prepared by, for example, mixing the crystalline resin A synthesized in advance and polymerizable monomers for generating the amorphous resin B, and other materials such as a magnetic body, a colorant, a release agent, and a charge control agent, as necessary, and uniformly dissolving or dispersing the materials.

Thereafter, the polymerizable monomer composition is dispersed in an aqueous medium using a stirrer or the like to prepare a suspended particle of the polymerizable monomer composition. Thereafter, the polymerizable monomers contained in the particle are polymerized using an initiator or the like to obtain a toner particle. After polymerization has finished, the toner particle is filtered, washed, and dried using known methods, and an external additive is added as necessary to obtain the toner.

A known polymerization initiator may be used. Examples of the polymerization initiator include: azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide polymerization initiators such as benzoyl peroxide, t-butyl peroxy-2-ethylhexanoate, t-butyl peroxypivalate, t-butyl peroxyisobutyrate, t-butyl peroxyneodecanoate, methylethylketone peroxide, diisopropyl peroxycarbonate, cumene hydroperoxide, 2,4-dichlorobenzoyl peroxide, and lauroyl peroxide. Also, a known chain transfer agent and a known polymerization inhibitor may be used.

The aqueous medium may contain an inorganic or organic dispersion stabilizer. A known dispersion stabilizer may be used. Examples of inorganic dispersion stabilizers include: phosphates such as hydroxyapatite, tribasic calcium phosphate, dibasic calcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

On the other hand, examples of organic dispersion stabilizers include polyvinyl alcohol, gelatin, methyl cellulose, methyl hydroxypropyl cellulose, ethyl cellulose, sodium salts of carboxymethyl cellulose, polyacrylic acid and salts thereof, and starch.

In the case where an inorganic compound is used as the dispersion stabilizer, a commercially available inorganic compound may be used as is, or the inorganic compound may be generated in an aqueous medium to obtain a finer particle. For example, in the case of calcium phosphate such as hydroxyapatite or tribasic calcium phosphate, an aqueous solution of the phosphate and an aqueous solution of a calcium salt may be mixed under high-speed stirring conditions.

The aqueous medium may contain a surfactant. A known surfactant may be used. Examples of the surfactant include: anionic surfactants such as sodium dodecylbenzenesulfate and sodium oleate; cationic surfactants; amphoteric surfactants; and nonionic surfactants.

The method for manufacturing the toner using the pulverization method is not particularly limited, but preferably includes: a step of melt-kneading raw materials including the crystalline resin A and the amorphous resin B and also including a magnetic body, a colorant, a release agent, and the like as necessary; and a step of pulverizing the obtained melt-kneaded product to obtain a toner particle. Known apparatuses may be used for melt-kneading and pulverization.

The emulsion aggregation method is not particularly limited, but preferably includes: a dispersion step of preparing solutions in which fine particles of raw materials (the crystalline resin A, the amorphous resin B, and a magnetic body, a colorant, a release agent, etc., as necessary) of a toner particle are dispersed; an aggregation step of causing aggregation of the fine particles of raw materials of a toner particle and controlling the particle diameter of an aggregated particle until the particle diameter reaches the particle diameter of a toner particle; and a melt adhesion step of causing melt adhesion of the resins contained in the obtained aggregated particle to obtain a toner particle.

A toner particle may also be obtained by performing, as necessary, a cooling step after the above-described step, filtration, a metal removal step of removing excessive polyvalent metal ions, a filtration and washing step of washing the toner particle with ion exchange water or the like, and a drying step of removing moisture from the washed toner particle.

The following describes methods for calculating and measuring various physical properties.

Method for Measuring Molecular Weight of Toner

The molecular weight (weight-average molecular weight Mw) of THF-soluble matter in the toner is measured using gel permeation chromatography (GPC) as described below. First, the toner is dissolved in tetrahydrofuran (THF) at room temperature over the course of 24 hours. The resulting solution is filtered through a solvent-resistant membrane filter (Maishori Disk, Tosoh Corp.) having a pore diameter of 0.2 μm to obtain a sample solution. The concentration of THF-soluble components in the sample solution is adjusted to about 0.8 mass %. Measurement is performed under the following conditions using this sample solution.
Device: HLC8120 GPC (detector: RI) (Tosoh Corp.)
Columns: Shodex KF-801, 802, 803, 804, 805, 806, 807 (total 7) (Showa Denko)
Eluent: Tetrahydrofuran (THF)
Flow rate: 1.0 mL/min
Oven temperature: 40.0° C.
Sample injection volume: 0.10 mL

A molecular weight calibration curve prepared using standard polystyrene resin (such as TSK standard polystyrene F-850, F-450, F-288, F-128, F-80, F-40, F-20, F-10, F-4, F-2, F-1, A-5000, A-2500, A-1000, A-500, Tosoh Corp.) is used for calculating the molecular weights of the samples.

Method for Separating Crystalline Resin A and Amorphous Resin B from Toner

The crystalline resin A and the amorphous resin B can be separated from the toner using a known method, and the following describes an example of such a method. Gradient LC is used as a method for separating resin components from the toner. With this analysis, it is possible to separate resins included in the binder resin in accordance with polarities of the resins, irrespective of molecular weights.

First, the toner is dissolved in chloroform. Measurement is carried out using a sample that is prepared by adjusting the concentration of the sample to 0.1 mass % using chloroform and filtering the solution using a 0.45—m PTFE filter. Gradient polymer LC measurement conditions are shown below.
Apparatus: UltiMate 3000 (manufactured by Thermo Fisher Scientific Inc.)
Mobile phase: A chloroform (HPLC), B acetonitrile (HPLC)
Gradient: 2 min (A/B=0/100)→25 min (A/B=100/0)
(The gradient of the change in mobile phase was adjusted to be linear.)
Flow rate: 1.0 mL/min
Injection: 0.1 mass %×20 μL
Column: Tosoh TSKgel ODS (4.6 mm (p×150 mm×5 m)
Column temperature: 40° C.
Detector: Corona charged particle detector (Corona-CAD) (manufactured by Thermo Fisher Scientific Inc.)

In a time-intensity graph obtained through the measurement, the resin components can be separated into two peaks in accordance with their polarities. It is possible to separate the two types of resins by thereafter carrying out the above-described measurement again and performing isolation at times corresponding to valleys after the respective peaks. DSC measurement and ¹H-NMR measurement are performed on the separated resins. Based on the result of the measurements, the crystalline resin A and the amorphous resin B are attributed.

In the case where other resin is contained separately from the crystalline resin A and the amorphous resin B, separation can be performed by performing separation by the Gradient LC, DSC measurement, and ¹H-NMR measurement.

Note that if the toner contains a release agent, it is necessary to separate the release agent from the toner. The release agent is separated by separating components having a molecular weight of 2000 or less using recycle HPLC. The following describes a measurement method. First, a chloroform solution of the toner is prepared using the above-described method. The obtained solution is filtered using a solvent-resistant membrane filter “Maishori Disk” (manufactured by Tosoh Corporation) having a pore diameter of 0.2 μm to obtain a sample solution. Note that the concentration of chloroform-soluble matter in the sample solution is adjusted to 1.0 mass %. Measurement is carried out using the sample solution under the following conditions.
Apparatus: LC-Sakura NEXT (manufactured by Japan Analytical Industry Co., Ltd.)
Column: JAIGEL2H, 4H (manufactured by Japan Analytical Industry Co., Ltd.)
Eluent: chloroform
Flow rate: 10.0 ml/min
Oven temperature: 40.0° C.
Sample injection amount: 1.0 ml

The molecular weight of the sample is calculated using a molecular weight calibration curve obtained using standard polystyrene resins (e.g., “TSK standard polystyrene F-850, F-450, F-288, F-128, F-80, F-40, F-20, F-10, F-4, F-2, F-1, A-5000, A-2500, A-1000, A-500” (product name) manufactured by Tosoh Corporation). The release agent is removed from the toner by repeatedly performing isolation of components having a molecular weight of 2000 or less using the obtained molecular weight curve.

Method for Measuring Percentages of Contents of Various Monomer Units in Resin

The percentages of contents of various monomer units in a resin are measured using ¹H-NMR under the following conditions. The crystalline resin A and the amorphous resin B isolated using the above-described method can be used as measurement samples.

Measurement apparatus: FT NMR apparatus JNM-EX400 (manufactured by JEOL Ltd.)
Measurement frequency: 400 MHz
Pulse condition: 5.0 μs
Frequency range: 10500 Hz
Cumulative number of times: 64 times
Measurement temperature: 30° C.

Sample: Prepared by placing 50 mg of a measurement sample in a sample tube having an inner diameter of 5 mm, adding deuterated chloroform (CDCl₃) as a solvent, and dissolving the measurement sample in a thermostatic chamber at 40° C. The structure of each monomer unit is identified by analyzing an obtained ¹H-NMR chart. By this identification, it can be confirmed that the crystalline resin A and the amorphous resin B have each monomer unit. The following describes measurement of the percentage of the content of the monomer unit (a) in the crystalline resin A as an example. In the obtained ¹H-NMR chart, a peak that is independent of peaks attributed to constituents of other monomer units is selected from among peaks attributed to constituents of the monomer unit (a), and an integration value S1 of the selected peak is calculated. An integration value is also calculated in the same manner with respect to other monomer units included in the crystalline resin A.

If monomer units constituting the crystalline resin A are the monomer unit (a) and another monomer unit, the percentage of the content of the monomer unit (a) is determined using the integration value S1 and an integration value S2 of a peak calculated for the other monomer unit. Note that n1 and n2 each represent the number of hydrogen atoms included in a constituent to which the peak focused on with respect to the corresponding unit is attributed.

Percentage(mol %) of content of monomer unit(a)={(S1/n1)/((S1/n1)+(S2/n2))}×100

In cases where the crystalline resin A includes two or more types of other monomer units, the percentage of the content of the monomer unit (a) can be calculated in the same manner (using S3 . . . . Sx and n3 . . . nx).

If a polymerizable monomer that does not include a hydrogen atom in constituents other than a vinyl group is used, measurement is carried out using ¹³C-NMR and setting the measurement atomic nucleus to ¹³C in a single pulse mode, and calculation is performed in the same manner using ¹H-NMR. The percentage of the content of each monomer unit is converted to a value expressed in mass % by multiplying the percentage (mol %) of the monomer unit calculated as described above by the molecular weight of the monomer unit. Measurement is carried out for the amorphous resin B as well using the same method.

Measurement of Percentage of Content of Crystalline Resin A and Amorphous Resin B in Toner

The percentage of the content of the crystalline resin A and the amorphous resin B in the toner is calculated based on the mass of the toner before the toner is dissolved in chloroform, the mass of the separated crystalline resin A and amorphous resin B in the above-described method for separating the crystalline resin A and the amorphous resin B from the toner.

Method for Calculating SPA and SPB

SPA and SPB are determined proceeding as follows using the calculation method proposed by Fedors. The energy of vaporization (Δei) (cal/mol) and the molar volume (Δvi) (cm³/mol) are determined from the tables given in “Polym. Eng. Sci., 14(2), 147-154 (1974)” for the atoms or atomic groups in each molecular structure, and (4.184×ΣΔei/ΣΔvi)^{0.5} is used for the SP value (J/cm³)^{0.5}.

Specifically, the energy of vaporization (Δei) and the molar volume (Δvi) of the monomer units corresponding to the monomers that constitute the crystalline resin A or the amorphous resin B are determined for each monomer unit; each product with the molar ratio (j) in the resin A of each monomer unit is calculated; and the determination is carried out by dividing the sum of the energies of vaporization of the individual monomer units by the sum of the molar volumes with calculation using the following formula (5).

SPA or SPB={4.184×(Σj×ΣΔei)/(Σj×ΣΔvi)}^{0.5} (5)

Measurement of The Glass Transition Temperature Tg of The Amorphous Resin B

The glass transition temperature (Tg) is measured using a “Q1000” differential scanning calorimeter (TA Instruments). The melting points of indium and zinc are used for temperature correction in the instrument detection section, and the heat of fusion of indium is used for correction of the amount of heat.

Specifically, 1 mg of the amorphous resin B is exactly weighed out and introduced into an aluminum pan; an empty aluminum pan is used for reference. Using modulation measurement mode, measurement is carried out in the range from 0° C. to 120° C. at a ramp rate of 1° C./minute and a temperature modulation condition of±0.6° C./60 s. Because a change in the specific heat is obtained during the temperature ramp up process, the glass transition temperature (Tg) is taken to be the point at the intersection between the differential heat curve and the line for the midpoint for the baselines for prior to and subsequent to the appearance of the change in the specific heat.

When the temperature region where the specific heat change appears overlaps with an endothermic peak for, e.g., the crystalline resin or wax, the specific heat change is then produced around an endothermic peak. In such a case, the glass transition temperature (Tg) is taken to be the intersection between the straight line connecting the heat absorption start temperature (onset temperature) of the endothermic peak and the temperature of completion of heat absorption (offset temperature), and the line for the midpoint for the baselines for prior to and subsequent to the appearance of the change in the specific heat.

Measurement of the Content of the Magnetic Body in The Toner

The content of the magnetic body in the toner can be measured using a TGAQ5000IR thermal analyzer from PerkinElmer Inc. The measurement method is as follows: the toner is heated to 900° C. from normal temperature at a ramp rate of 25° C./minute in a nitrogen atmosphere, and the mass loss at 100° C. to 750° C. is taken to be the component from the toner excluding the magnetic body and the remaining mass is taken to be the amount of the magnetic body.

### EXAMPLES

The following describes the present invention in more detail using examples, but the present invention is not limited by the examples. In formulations described below, “parts” means “parts by mass”, unless otherwise stated.

### Crystalline Resin A1 Preparation Example

The following materials were introduced under a nitrogen atmosphere into a reactor fitted with a reflux condenser, stirrer, thermometer, and nitrogen introduction line.

| | | |
|---|---|---|
| toluene | 100.0 | parts |
| monomer composition | 100.0 | parts |
| (the monomer composition is provided by mixing | | |
| the following monomers in the following proportions) | | |
| (behenyl acrylate (monomer (a)) | 80.0 | parts) |
| (styrene | 18.0 | parts) |
| (methacrylic acid | 2.0 | parts) |
| polymerization initiator: t-butyl peroxypivalate | 0.5 | parts |
| (PERBUTYL PV, NOF Corporation) | | |

While stirring in the aforementioned reactor at 200 rpm, a polymerization reaction was run for 12 hours with heating to 70° C. to obtain a solution in which a polymer of the monomer composition was dissolved in toluene. This solution was then cooled to 25° C. followed by the introduction of the solution while stirring into 1000.0 parts of methanol to precipitate methanol-insoluble matter. The resulting methanol-insoluble matter was filtered off and was additionally washed with methanol, followed by vacuum drying for 24 hours at 40° C. to yield a crystalline resin A1.

Crystalline Resins A2 to All Preparation Example

Crystalline resins A2 to All were prepared proceeding entirely as in the crystalline resin A1 Preparation Example, but changing the amount of addition of the monomer composition as indicated in Table 1.

TABLE 1

| | Monomer (a) | | | Other monomer 1 | | Other monomer 2 | | Other monomer 3 | | | |
|---|---|---|---|---|---|---|---|---|---|---|---|
| | | Number | Amount | | Amount | | Amount | | Amount | Resin properties | |
| | | of | of | | of | | of | | of | Unit (a) | |
| | | carbons | addition | | addition | | addition | | addition | content | SPA |
| C.R. A | Species | m | (parts) | Species | (parts) | Species | (parts) | Species | (parts) | (mass %) | [(J/cm³)^{0.5}] |
| C.R. A1 | Behenyl acrylate | 21 | 80.0 | Styrene | 18.0 | Methacrylic | 2.0 | — | — | 80.0 | 18.69 |
| | | | | | | acid | | | | | |
| C.R. A2 | Stearyl acrylate | 17 | 40.0 | Styrene | 18.0 | Methacrylic | 2.0 | — | — | 80.0 | 18.80 |
| | Behenyl acrylate | 21 | 40.0 | | | acid | | | | | |
| C.R. A3 | Behenyl acrylate | 21 | 75.0 | Styrene | 18.0 | Methacrylic | 2.0 | — | — | 80.0 | 18.54 |
| | Myricyl acrylate | 29 | 5.0 | | | acid | | | | | |
| C.R. A4 | Behenyl acrylate | 21 | 52.0 | Styrene | 46.0 | Methacrylic | 2.0 | — | — | 52.0 | 19.21 |
| | | | | | | acid | | | | | |
| C.R. A5 | Behenyl acrylate | 21 | 65.0 | Styrene | 33.0 | Methacrylic | 2.0 | — | — | 65.0 | 18.97 |
| | | | | | | acid | | | | | |
| C.R. A6 | Behenyl acrylate | 21 | 73.0 | Styrene | 25.0 | Methacrylic | 2.0 | — | — | 73.0 | 18.82 |
| | | | | | | acid | | | | | |
| C.R. A7 | Behenyl acrylate | 21 | 95.0 | Styrene | 3.0 | Methacrylic | 2.0 | — | — | 95.0 | 18.51 |
| | | | | | | acid | | | | | |
| C.R. A8 | Behenyl acrylate | 21 | 75.0 | Styrene | 8.0 | Methacrylic | 2.0 | Methacrylonitrile | 15.0 | 75.0 | 19.59 |
| | | | | | | acid | | | | | |
| C.R. A9 | Lauryl acrylate | 11 | 80.0 | Styrene | 18.0 | Methacrylic | 2.0 | — | — | 80.0 | 19.68 |
| | | | | | | acid | | | | | |
| C.R. A10 | Behenyl acrylate | 21 | 48.0 | Styrene | 50.0 | Methacrylic | 2.0 | — | — | 48.0 | 19.53 |
| | | | | | | acid | | | | | |
| C.R. A11 | Behenyl acrylate | 21 | 70.0 | Styrene | 12.0 | Methacrylic | 2.0 | Methacrylonitrile | 16.0 | 70.0 | 19.74 |
| | | | | | | acid | | | | | |

In Table 1, C.R. represents Crystalline resin.

Amorphous Resin B1 Preparation Example

The following materials were introduced under a nitrogen atmosphere into a reactor fitted with a reflux condenser, stirrer, thermometer, and nitrogen introduction line.

| | | |
|---|---|---|
| toluene | 100.0 | parts |
| monomer composition | 100.0 | parts |
| (the monomer composition is provided by mixing | | |
| the following monomers in the following proportions) | | |
| (lauryl acrylate | 25.0 | parts) |
| (styrene | 75.0 | parts) |
| polymerization initiator: t-butyl peroxypivalate | 0.5 | parts |
| (PERBUTYL PV, NOF Corporation) | | |

While stirring in the aforementioned reactor at 200 rpm, a polymerization reaction was run for 12 hours with heating to 70° C. to obtain a solution in which a polymer of the monomer composition was dissolved in toluene. This solution was then cooled to 25° C. followed by the introduction of the solution while stirring into 1000.0 parts of methanol to precipitate methanol-insoluble matter. The resulting methanol-insoluble matter was filtered off and was additionally washed with methanol, followed by vacuum drying for 24 hours at 40° C. to yield an amorphous resin B 1.

### Resin C1 Preparation Example

The following starting materials were introduced into a reactor fitted with a condenser, stirrer, and nitrogen introduction line and a reaction was run for 15 hours at 220° C. under normal pressure, followed by additional reaction for 0.5 hours under a reduced pressure of 1.3 to 2.6 kPa.

| | | |
|---|---|---|
| terephthalic acid | 210.0 | parts |
| isophthalic acid | 210.0 | parts |
| 2 mol propylene oxide adduct on bisphenol A | 1200.0 | parts |
| potassium titanium oxalate | 0.3 | parts |

The temperature was then dropped to 180° C. and 0.01 parts trimellitic anhydride was added and a reaction was run for 1.5 hours at 180° C. to obtain a resin Cl.

Treated Magnetic Body Production Example

The following were mixed into an aqueous ferrous sulfate solution: a sodium hydroxide solution at 1.00 to 1.10 equivalents with reference to the iron atom, P₂O₅ in an amount that provided 0.15 mass % as the phosphorus atom with reference to the iron atom, and SiO₂ in an amount that provided 0.50 mass % as the silicon atom with reference to the iron atom. This was followed by the preparation of an aqueous solution containing ferrous hydroxide. The pH of this aqueous solution was brought to 8.0 and an oxidation reaction was run at 85° C. while bubbling in air to prepare a seed crystal-containing slurry.

An aqueous ferrous sulfate solution was then added to this slurry so as to provide from 0.90 to 1.20 equivalents with reference to the initial amount of alkali (sodium component of the sodium hydroxide). The slurry was then held at pH 7.6 and an oxidation reaction was run while bubbling in air to obtain a slurry containing magnetic iron oxide. The resulting slurry was filtered and washed and the wet slurry was temporarily recovered. At this point, a small amount of the wet slurry was collected and the water content was measured. This wet slurry was then introduced, without drying, into a separate aqueous medium and redispersion was carried out using a pin mill while circulating the slurry and also stirring; the pH of the redispersion was adjusted to 4.8 using an inorganic acid, e.g., hydrochloric acid.

While stirring, n-hexyltrimethoxysilane as coupling agent was added at 1.6 parts per 100 parts of the magnetic iron oxide (the amount of the magnetic iron oxide was calculated as the value provided by subtracting the water content from the wet slurry) and hydrolysis was carried out. A hydrophobic treatment was then carried out by stirring and bringing the pH of the dispersion to 8.6. The produced hydrophobic magnetic body was filtered using a filter press and was washed with a large volume of water, followed by drying for 15 minutes at 100° C. and then 30 minutes at 90° C. The obtained particles were then subjected to a crushing treatment to obtain a treated magnetic body having a volume-average particle diameter of 0.21 μm.

### Example 1

Toner Production by Suspension Polymerization

### Toner Particle 1 Production Example

| | |
|---|---|
| lauryl acrylate | 15.0 parts |
| styrene | 45.0 parts |
| treated magnetic body | 65.0 parts |

A mixture of these materials was prepared. This mixture was introduced into an attritor (Nippon Coke & Engineering Co., Ltd.), and a starting material dispersion was obtained by dispersing for 2 hours at 200 rpm using zirconia beads with a diameter of 5 mm.

Otherwise, 735.0 parts of deionized water and 16.0 parts of trisodium phosphate (dodecahydrate) were added to a vessel outfitted with a Homomixer high-speed stirrer (PRIMIX Corporation) and a thermometer, and the temperature was raised to 60° C. while stirring at 12,000 rpm. To this was added an aqueous calcium chloride solution of 9.0 parts calcium chloride (dihydrate) dissolved in 65.0 parts deionized water, and stirring was carried out for 30 minutes at 12,000 rpm while maintaining 60° C. To this was added 10% hydrochloric acid to adjust the pH to 6.0 and obtain an aqueous medium in which a hydroxyapatite-containing inorganic dispersion stabilizer was dispersed in water.

The aforementioned starting material dispersion was then transferred to a vessel equipped with a stirrer and thermometer and the temperature was raised to 60° C. while stirring at 100 rpm.

| | | |
|---|---|---|
| crystalline resin A1 | 40.0 | parts |
| release agent 1 | 9.0 | parts |

(release agent 1: DP18 (dipentaerythritol stearate ester wax, melting point=79° C., Nippon Seiro Co., Ltd.))

These materials were added to the preceding and stirring was performed for 30 minutes at 100 rpm while holding at 60° C.; 9.0 parts of the polymerization initiator t-butyl peroxypivalate (PERBUTYL PV, NOF Corporation) was then added and stirring was carried out for an additional 1 minute; and introduction was subsequently carried out into the aqueous medium that was being stirred at 12,000 rpm with the high-speed stirrer. Stirring was continued for 20 minutes at 12,000 rpm with the high-speed stirrer while holding at 60° C. to obtain a granulation solution.

The granulation solution was transferred to a reactor outfitted with a reflux condenser, stirrer, thermometer, and nitrogen introduction line, and the temperature was raised to 70° C. while stirring at 150 rpm under a nitrogen atmosphere. A polymerization reaction was run for 12 hours at 150 rpm while holding at 70° C. to obtain a toner particle dispersion. The resulting toner particle dispersion was cooled to 45° C. while stirring at 150 rpm, and, while keeping the 45° C., a heat treatment was subsequently performed for 5 hours. Then, while holding the stirring without change, dilute hydrochloric acid was added to bring the pH to 1.5 and the dispersion stabilizer was dissolved. The solid fraction was filtered off and thoroughly washed with deionized water, followed by vacuum drying for 24 hours at 30° C. to obtain a toner particle 1.

### Toner 1 Preparation Example

2.0 parts of silica fine particles (hydrophobically treated with hexamethyldisilazane, number-average primary particle diameter: 10 nm, BET specific surface area: 170 m²/g) as an external additive was added per 98.0 parts of the obtained toner particle 1, and mixing was carried out for 15 minutes at 3,000 rpm using a Henschel mixer (Nippon Coke & Engineering Co., Ltd.) to obtain a toner 1.

The properties of the obtained toner 1 are given in Tables 3-1 and 3-2 and the results of its evaluation are given in Table 4.

TABLE 2-1

| | | | Binder resin | | | | | | |
|---|---|---|---|---|---|---|---|---|---|
| | | | | | Amorphous resin B | | | | |
| | | | Crystalline resin A | | Polymerizable monomer X | | | Polymerizable monomer Y | |
| | | | | Amount of | | Number of | Amount of | | Amount of |
| | | Production | | addition | | carbons | addition | | addition |
| | Toner No. | method | Species | (parts) | Species | n | (parts) | Species | (parts) |
| Example 1 | 1 | S.P. | A1 | 40.0 | Lauryl acrylate | 11 | 15.0 | Styrene | 45.0 |
| Example 2 | 2 | S.P. | A2 | 40.0 | Lauryl acrylate | 11 | 15.0 | Styrene | 45.0 |
| Example 3 | 3 | S.P. | A3 | 40.0 | Lauryl acrylate | 11 | 15.0 | Styrene | 45.0 |
| Example 4 | 4 | S.P. | A4 | 40.0 | Lauryl acrylate | 11 | 15.0 | Styrene | 45.0 |
| Example 5 | 5 | S.P. | A5 | 40.0 | Lauryl acrylate | 11 | 15.0 | Styrene | 45.0 |
| Example 6 | 6 | S.P. | A6 | 40.0 | Lauryl acrylate | 11 | 15.0 | Styrene | 45.0 |
| Example 7 | 7 | S.P. | A7 | 40.0 | Lauryl acrylate | 11 | 15.0 | Styrene | 45.0 |
| Example 8 | 8 | S.P. | A1 | 12.0 | Lauryl acrylate | 11 | 22.0 | Styrene | 66.0 |
| Example 9 | 9 | S.P. | A1 | 18.0 | Lauryl acrylate | 11 | 20.5 | Styrene | 61.5 |
| Example 10 | 10 | S.P. | A1 | 62.0 | Lauryl acrylate | 11 | 14.4 | Styrene | 23.6 |
| Example 11 | 11 | S.P. | A1 | 68.0 | Lauryl acrylate | 11 | 8.0 | Styrene | 24.0 |
| Example 13 | 13 | S.P. | A1 | 68.0 | Lauryl acrylate | 11 | 13.8 | Styrene | 18.2 |
| Example 14 | 14 | S.P. | A1 | 40.0 | Lauryl acrylate | 11 | 9.5 | Styrene | 28.5 |
| Example 15 | 15 | S.P. | A1 | 20.0 | Lauryl acrylate | 11 | 20.0 | Styrene | 60.0 |
| Example 16 | 16 | S.P. | A1 | 40.0 | Behenyl acrylate | 21 | 15.0 | Styrene | 45.0 |
| Example 17 | 17 | S.P. | A8 | 40.0 | Lauryl acrylate | 11 | 15.0 | Styrene | 45.0 |
| Example 18 | 18 | S.P. | A1 | 40.0 | Lauryl acrylate | 11 | 15.0 | Styrene | 36.0 |
| Example 19 | 19 | S.P. | A1 | 40.0 | Lauryl acrylate | 11 | 1.8 | Styrene | 58.2 |
| Example 20 | 20 | S.P. | A1 | 40.0 | Lauryl acrylate | 11 | 4.8 | Styrene | 55.2 |
| Example 21 | 21 | S.P. | A1 | 40.0 | Lauryl acrylate | 11 | 22.8 | Styrene | 37.2 |
| Example 22 | 22 | S.P. | A1 | 40.0 | Lauryl acrylate | 11 | 25.8 | Styrene | 34.2 |
| Example 23 | 23 | S.P. | A1 | 40.0 | Lauryl acrylate | 11 | 15.0 | Methyl | 45.0 |
| | | | | | | | | methacrylate | |
| Example 24 | 24 | S.P. | A1 | 40.0 | Lauryl acrylate | 11 | 15.0 | Styrene | 50.0 |
| Example 27 | 27 | S.P. | A1 | 40.0 | Lauryl acrylate | 11 | 5.0 | Styrene | 15.0 |
| Example 28 | 28 | S.P. | A1 | 20.0 | Lauryl acrylate | 11 | 20.0 | Styrene | 60.0 |
| C.E. 1 | Comparative 1 | S.P. | A9 | 40.0 | Lauryl acrylate | 11 | 15.0 | Styrene | 45.0 |
| C.E. 2 | Comparative 2 | S.P. | A10 | 40.0 | Lauryl acrylate | 11 | 15.0 | Styrene | 45.0 |
| C.E. 3 | Comparative 3 | S.P. | A1 | 10.0 | Lauryl acrylate | 11 | 22.5 | Styrene | 67.5 |
| C.E. 5 | Comparative 5 | S.P. | A1 | 40.0 | — | — | — | Styrene | 60.0 |
| C.E. 6 | Comparative 6 | S.P. | A11 | 40.0 | Lauryl acrylate | 11 | 15.0 | Styrene | 45.0 |
| C.E. 7 | Comparative 7 | S.P. | A1 | 40.0 | Lauryl acrylate | 11 | 15.0 | Styrene | 31.8 |
| C.E. 8 | Comparative 8 | S.P. | A1 | 40.0 | Lauryl acrylate | 11 | 15.0 | Styrene | 45.0 |
| C.E. 9 | Comparative 91 | S.P. | A1 | 20.0 | Lauryl acrylate | 11 | 7.5 | Styrene | 22.5 |

TABLE 2-2

| | Binder resin | | | | | |
|---|---|---|---|---|---|---|
| | Amorphous resin B | | | | | Magnetic |
| | Polymerizable monomer Z | | | Other resin | | body |
| | | Amount of | Glass transition | | Amount of | Amount of |
| | | addition | temperature | | addition | addition |
| | Species | (parts) | (° C.) | Species | (parts) | (parts) |
| Example 1 | — | — | 47.3 | — | — | 65.0 |
| Example 2 | — | — | 47.3 | — | — | 65.0 |
| Example 3 | — | — | 47.3 | — | — | 65.0 |
| Example 4 | — | — | 47.3 | — | — | 65.0 |
| Example 5 | — | — | 47.3 | — | — | 65.0 |
| Example 6 | — | — | 47.3 | — | — | 65.0 |
| Example 7 | — | — | 47.3 | — | — | 65.0 |
| Example 8 | — | — | 47.3 | — | — | 65.0 |
| Example 9 | — | — | 47.3 | — | — | 65.0 |
| Example 10 | — | — | 47.3 | — | — | 65.0 |
| Example 11 | — | — | 47.3 | — | — | 50.0 |
| Example 13 | — | — | 47.3 | — | — | 65.0 |
| Example 14 | — | — | 47.3 | C1 | 22.0 | 65.0 |
| Example 15 | — | — | 47.3 | — | — | 25.0 |
| Example 16 | — | — | 44.2 | — | — | 65.0 |
| Example 17 | — | — | 47.3 | — | — | 65.0 |
| Example 18 | Methacrylonitrile | 9.0 | 50.0 | — | — | 65.0 |
| Example 19 | — | — | 80.0 | — | — | 65.0 |
| Example 20 | — | — | 78.0 | — | — | 65.0 |
| Example 21 | — | — | 39.0 | — | — | 65.0 |
| Example 22 | — | — | 34.0 | — | — | 65.0 |
| Example 23 | — | — | 47.8 | — | — | 65.0 |
| Example 24 | t-butyl methacrylate | 25.0 | 45.8 | — | — | 65.0 |
| Example 27 | — | — | 47.3 | C1 | 40.0 | 65.0 |
| Example 28 | — | — | 47.3 | — | — | 100.0 |
| C.E. 1 | — | — | 47.3 | — | — | 65.0 |
| C.E. 2 | — | — | 47.3 | — | — | 65.0 |
| C.E. 3 | — | — | 47.3 | — | — | 65.0 |
| C.E. 5 | — | — | 90.0 | — | — | 65.0 |
| C.E. 6 | — | — | 47.3 | — | — | 65.0 |
| C.E. 7 | Methacrylonitrile | 13.2 | 50.0 | — | — | 65.0 |
| C.E. 8 | — | — | 47.3 | — | — | 250.0 |
| C.E. 9 | — | — | 47.3 | C1 | 50.0 | 65.0 |

In the Tables 2-1 and 2-2, C1 indicates resin C1, C. E. indicates Comparative Example, and S. P. indicates Suspension polymerization.

TABLE 3-1

| | | | | Content of |
|---|---|---|---|---|
| | | | | crystalline resin A |
| | Toner | | SPB − SPA | in the toner |
| | No. | Production method | [(J/cm³)^{0.5}] | (mass %) |
| Example 1 | 1 | Suspension polymerization | 1.07 | 22.7 |
| Example 2 | 2 | Suspension polymerization | 0.96 | 22.7 |
| Example 3 | 3 | Suspension polymerization | 1.22 | 22.7 |
| Example 4 | 4 | Suspension polymerization | 0.55 | 22.7 |
| Example 5 | 5 | Suspension polymerization | 0.79 | 22.7 |
| Example 6 | 6 | Suspension polymerization | 0.94 | 22.7 |
| Example 7 | 7 | Suspension polymerization | 1.25 | 22.7 |
| Example 8 | 8 | Suspension polymerization | 1.07 | 6.8 |
| Example 9 | 9 | Suspension polymerization | 1.07 | 10.2 |
| Example 10 | 10 | Suspension polymerization | 1.07 | 35.2 |
| Example 11 | 11 | Suspension polymerization | 1.07 | 42.2 |
| Example 12 | 12 | Pulverization | 1.07 | 70.6 |
| Example 13 | 13 | Suspension polymerization | 1.07 | 38.6 |
| Example 14 | 14 | Suspension polymerization | 1.07 | 22.7 |
| Example 15 | 15 | Suspension polymerization | 1.07 | 14.7 |
| Example 16 | 16 | Suspension polymerization | 0.94 | 22.7 |
| Example 17 | 17 | Suspension polymerization | 0.17 | 22.7 |
| Example 18 | 18 | Suspension polymerization | 1.90 | 22.7 |
| Example 19 | 19 | Suspension polymerization | 1.35 | 22.7 |
| Example 20 | 20 | Suspension polymerization | 1.34 | 22.7 |
| Example 21 | 21 | Suspension polymerization | 1.01 | 22.7 |
| Example 22 | 22 | Suspension polymerization | 0.97 | 22.7 |
| Example 23 | 23 | Suspension polymerization | 1.17 | 22.7 |
| Example 24 | 24 | Suspension polymerization | 1.07 | 22.7 |
| Example 25 | 25 | Pulverization | 1.07 | 22.7 |
| Example 26 | 26 | Emulsion aggregation | 1.07 | 22.7 |
| Example 27 | 27 | Suspension polymerization | 1.07 | 22.7 |
| Example 28 | 28 | Suspension polymerization | 1.07 | 9.5 |
| C.E.1 | Comparative 1 | Suspension polymerization | 0.08 | 22.7 |
| C.E.2 | Comparative 2 | Suspension polymerization | 0.23 | 22.7 |
| C.E.3 | Comparative 3 | Suspension polymerization | 1.07 | 5.7 |
| C.E.4 | Comparative 4 | Pulverization | — | 56.8 |
| C.E.5 | Comparative 5 | Suspension polymerization | 1.38 | 22.7 |
| C.E.6 | Comparative 6 | Suspension polymerization | 0.02 | 22.7 |
| C.E.7 | Comparative 7 | Suspension polymerization | 2.29 | 22.7 |
| C.E.8 | Comparative 8 | Suspension polymerization | 1.07 | 11.1 |
| C.E.9 | Comparative 9 | Suspension polymerization | 1.07 | 11.4 |
| C.E.10 | Comparative 10 | Pulverization | — | 45.5 |

TABLE 3-2

| | | Content of | Content of | Content of | |
|---|---|---|---|---|---|
| | Content of | crystalline resin A + | monomer unit (a) | monomer unit (b) | |
| | amorphous resin | amorphous resin B | in crystalline | in amorphous | |
| | B in the toner | in the toner | resin A | resin 8 | Mw of the |
| | (mass %) | (mass %) | (mass %) | (mass %) | toner |
| Example 1 | 34.1 | 56.8 | 80.0 | 25.0 | 102500 |
| Example 2 | 34.1 | 56.8 | 80.0 | 25.0 | 124050 |
| Example 3 | 34.1 | 56.8 | 80.0 | 25.0 | 87900 |
| Example 4 | 34.1 | 56.8 | 52.0 | 25.0 | 93800 |
| Example 5 | 34.1 | 56.8 | 65.0 | 25.0 | 107300 |
| Example 6 | 34.1 | 56.8 | 73.0 | 25.0 | 99800 |
| Example 7 | 34.1 | 56.8 | 95.0 | 25.0 | 103800 |
| Example 8 | 50.0 | 56.8 | 80.0 | 25.0 | 101800 |
| Example 9 | 46.6 | 56.8 | 80.0 | 25.0 | 92450 |
| Example 10 | 21.6 | 56.8 | 80.0 | 25.0 | 95700 |
| Example 11 | 19.9 | 62.1 | 80.0 | 25.0 | 81800 |
| Example 12 | 2.9 | 73.5 | 80.0 | 38.0 | 83650 |
| Example 13 | 18.2 | 56.8 | 80.0 | 43.0 | 76350 |
| Example 14 | 21.6 | 44.3 | 80.0 | 25.0 | 94800 |
| Example 15 | 58.8 | 73.5 | 80.0 | 25.0 | 63800 |
| Example 16 | 34.1 | 56.8 | 80.0 | 25.0 | 65700 |
| Example 17 | 34.1 | 56.8 | 75.0 | 25.0 | 94250 |
| Example 18 | 34.1 | 56.8 | 80.0 | 25.0 | 96600 |
| Example 19 | 34.1 | 56.8 | 80.0 | 3.0 | 82640 |
| Example 20 | 34.1 | 56.8 | 80.0 | 8.0 | 96700 |
| Example 21 | 34.1 | 56.8 | 80.0 | 38.0 | 110080 |
| Example 22 | 34.1 | 56.8 | 80.0 | 43.0 | 94800 |
| Example 23 | 34.1 | 56.8 | 80.0 | 25.0 | 101800 |
| Example 24 | 34.1 | 56.8 | 80.0 | 25.0 | 101400 |
| Example 25 | 34.1 | 56.8 | 80.0 | 25.0 | 86800 |
| Example 26 | 34.1 | 56.8 | 80.0 | 25.0 | 87400 |
| Example 27 | 11.4 | 34.1 | 80.0 | 25.0 | 89100 |
| Example 28 | 37.9 | 47.4 | 80.0 | 25.0 | 93210 |
| C.E.1 | 34.1 | 56.8 | 80.0 | 25.0 | 94550 |
| C.E.2 | 34.1 | 56.8 | 48.0 | 25.0 | 101050 |
| C.E.3 | 51.1 | 56.8 | 80.0 | 25.0 | 113400 |
| C.E.4 | 0.0 | 56.8 | 80.0 | 0.0 | 78550 |
| C.E.5 | 34.1 | 56.8 | 80.0 | 0.0 | 100480 |
| C.E.6 | 34.1 | 56.8 | 70.0 | 25.0 | 88650 |
| C.E.7 | 34.1 | 56.8 | 80.0 | 25.0 | 91540 |
| C.E.8 | 16.6 | 27.7 | 80.0 | 25.0 | 92360 |
| C.E.9 | 17.0 | 28.4 | 80.0 | 25.0 | 10200 |
| C.E.10 | 0.0 | 45.5 | 70.0 | 0.0 | 74150 |

In the Tables 3-1 and 3-2, the Mw of the toner is the weight-average molecular weight Mw of the THF-soluble matter of the toner, and C. E. represents Comparative Example.

Toners 2 to 11, 13 to 24, 27, and 28

Toner particles 2 to 11, 13 to 24, 27, and 28 were obtained proceeding entirely as in Example 1, but changing as shown in Tables 2-1 and 2-2, the species and amount of addition of the polymerizable monomer that was used.

Toners 2 to 11, 13 to 24, 27, and 28 were obtained by carrying out the same external addition as in Example 1. The properties of the toners are given in Tables 3-1 and 3-2, and the results of their evaluation are given in Table 4. According to the previously described analyses, each monomer unit forming the crystalline resin A in toners 2 to 11, 13 to 24, 27, and 28 was incorporated in the same proportions as the formulations described in Table 1. In addition, each monomer unit forming the amorphous resin B was incorporated in the same proportions as the formulations described in Tables 2-1 and 2-2.

### Example 12

### Example of Toner Production by a Pulverization Method

| | | |
|---|---|---|
| crystalline resin A1 | 96.0 | parts |
| amorphous resin B1 | 4.0 | parts |
| treated magnetic body | 25.0 | parts |
| release agent 1 | 9.0 | parts |

These materials were pre-mixed using an FM mixer (Nippon Coke & Engineering Co., Ltd.) followed by melt-kneading with a twin-screw kneading extruder (Model PCM-30, Ikegai Ironworks Corporation).

The resulting kneaded material was cooled and coarsely pulverized using a hammer mill and was then pulverized using a mechanical pulverizer (T-250, Turbo Kogyo Co., Ltd.). The resulting finely pulverized powder was classified using a Coanda effect-based multi-grade classifier to yield a toner particle 12 having a weight-average particle diameter (D4) of 6.9 μm.

Toner 12 was obtained by carrying out the same external addition as in Example 1 on the toner particle 12. The properties of toner 12 are given in Tables 3-1 and 3-2, and the results of its evaluation are given in Table 4. According to the previously described analyses, each monomer unit forming the crystalline resin A1 in toner 12 was incorporated in the same proportions as the formulation for the production of the crystalline resin A1. In addition, each monomer unit forming the amorphous resin B1 was incorporated in the same proportions as the formulation for the production of the amorphous resin B 1.

### Example 25

A toner particle 25 was obtained proceeding entirely as in Example 12, but changing the amounts of addition of the individual materials used as indicated below. Toner 25 was obtained by carrying out the same external addition as in Example 1 on the toner particle 25. The properties of the toner are given in Tables 3-1 and 3-2, and the results of its evaluation are given in Table 4. According to the previously described analyses, each monomer unit forming the crystalline resin A1 in toner 25 was incorporated in the same proportions as the formulation for the production of the crystalline resin A1. In addition, each monomer unit forming the amorphous resin B1 was incorporated in the same proportions as the formulation for the production of the amorphous resin Bl.

| | | |
|---|---|---|
| crystalline resin A1 | 40.0 | parts |
| amorphous resin B1 | 60.0 | parts |
| treated magnetic body | 65.0 | parts |
| release agent 1 | 9.0 | parts |

### Example 26

### Example of Toner Production by an Emulsion Aggregation Method

### Example of the Preparation of a Crystalline Resin Dispersion

| | |
|---|---|
| toluene | 300.0 parts |
| crystalline resin A1 | 100.0 parts |

These materials were weighed out and mixed and dissolution was carried out at 90° C.

Separately, 5.0 parts of sodium dodecylbenzenesulfonate and 10.0 parts of sodium laurate were added to 700.0 parts of deionized water and dissolution was carried out with heating at 90° C. The toluene solution was then mixed with the aqueous solution and stirring at 7,000 rpm was performed using a T. K. Robomix ultrahigh-speed stirrer (PRIMIX Corporation).

Emulsification was performed at a pressure of 200 MPa using a Nanomizer high-pressure impact-type disperser (Yoshida Kikai Co., Ltd.). The toluene was subsequently removed using an evaporator and the concentration was adjusted using deionized water to yield a crystalline resin dispersion having a 20% concentration of crystalline resin A1 fine particles.

The 50% particle diameter (D50) on a volume basis of the crystalline resin A1 fine particles was measured at 0.40 μm using a Nanotrac UPA-EX150 dynamic light-scattering particle size distribution analyzer (Nikkiso Co., Ltd.).

### Example of the Preparation of an Amorphous Resin Dispersion

| | |
|---|---|
| toluene | 300.0 parts |
| amorphous resin B1 | 100.0 parts |

These materials were weighed out and mixed and dissolution was carried out at 90° C.

Separately, 5.0 parts of sodium dodecylbenzenesulfonate and 10.0 parts of sodium laurate were added to 700.0 parts of deionized water and dissolution was carried out with heating at 90° C. The toluene solution was then mixed with the aqueous solution and stirring at 7,000 rpm was performed using a T. K. Robomix ultrahigh-speed stirrer (PRIMIX Corporation).

Emulsification was performed at a pressure of 200 MPa using a Nanomizer high-pressure impact-type disperser (Yoshida Kikai Co., Ltd.). The toluene was subsequently removed using an evaporator and the concentration was adjusted using deionized water to yield an amorphous resin dispersion having a 20% concentration of amorphous resin fine particles.

The 50% particle diameter (D50) on a volume basis of the amorphous resin fine particles was measured at 0.38 μm using a Nanotrac UPA-EX150 dynamic light-scattering particle size distribution analyzer (Nikkiso Co., Ltd.).

### Example of the Preparation of a Release Agent Dispersion

| | | |
|---|---|---|
| release agent 1 | 100.0 | parts |
| Neogen RK anionic surfactant | 5.0 | parts |
| (Dai-ichi Kogyo Seiyaku Co., Ltd.) | | |
| deionized water | 395.0 | parts |

The preceding materials were weighed and introduced into a mixing container equipped with a stirrer and were heated to 90° C., and a dispersion treatment was then carried out for 60 minutes by circulation to a ClearMix W-Motion (M Technique Co., Ltd.). The conditions in the dispersion treatment were as follows.
rotor outer diameter=3 cm
clearance=0.3 mm
rotor rotation rate=19,000 r/min
screen rotation rate=19,000 r/min

After the dispersion treatment, cooling to 40° C. was carried out using cooling process conditions of a rotor rotation rate of 1,000 r/min, a screen rotation rate of 0 r/min, and a cooling rate of 10° C./min, to obtain a release agent dispersion having a 20% concentration of release agent fine particles.

The 50% particle diameter (D50) on a volume basis of the release agent fine particles was measured at 0.15 μm using a Nanotrac UPA-EX150 dynamic light-scattering particle size distribution analyzer (Nikkiso Co., Ltd.).

### Example of the Preparation of a Magnetic Body Dispersion

| | | |
|---|---|---|
| treated magnetic body | 65.0 | parts |
| Neogen RK anionic surfactant | 7.5 | parts |
| (Dai-ichi Kogyo Seiyaku Co., Ltd.) | | |
| deionized water | 442.5 | parts |

These materials were weighed out and mixed and dissolved, and dispersion was carried out for 1 hour using a Nanomizer high-pressure impact-type disperser (Yoshida Kikai Co., Ltd.) to yield a magnetic body dispersion, in which the treated magnetic body was dispersed, having a 12.6% concentration of the treated magnetic body. The 50% particle diameter (D50) on a volume basis of the treated magnetic body was measured at 0.20 μm using a Nanotrac UPA-EX150 dynamic light-scattering particle size distribution analyzer (Nikkiso Co., Ltd.).

### Toner 26 Production Example

| | | |
|---|---|---|
| crystalline resin dispersion | 200.0 | parts |
| amorphous resin dispersion | 300.0 | parts |
| release agent dispersion | 45.0 | parts |
| magnetic body dispersion | 65.0 | parts |
| deionized water | 160.0 | parts |

These materials were introduced into a round stainless steel flask and were mixed. Dispersion was then carried out for 10 minutes at 5,000 r/min using an Ultra-Turrax T50 homogenizer (IKA). The pH was adjusted to 3.0 by adding a 1.0% aqueous nitric acid solution, and heating was subsequently carried out to 58° C. on a heating water bath while adjusting the rotation rate of a stirring blade as appropriate so the mixture was stirred.

The volume-average particle diameter of the aggregated particles that were formed was checked as appropriate using a Coulter Multisizer III, and, once aggregated particles having a weight-average particle diameter (D4) of 6.0 μm had been formed, the pH was brought to 9.0 using a 5% aqueous sodium hydroxide solution. Heating to 75° C. was then carried out while continuing to stir. Aggregated particle coalescence was brought about by holding for 1 hour at 75° C.

This was followed by cooling to 45° C. and execution of a heat treatment for 5 hours. This was followed by cooling to 25° C., filtration and solid-liquid separation, and then washing with deionized water. After the completion of washing, drying using a vacuum dryer yielded a toner particle 26 having a weight-average particle diameter (D4) of 6.1 μm. Toner 26 was obtained by carrying out the same external addition as in Example 1 on the toner particle 26. The properties of toner 26 are given in Tables 3-1 and 3-2, and the results of its evaluation are given in Table 4. According to the previously described analyses, each monomer unit forming the crystalline resin A1 in toner 26 was incorporated in the same proportions as the formulation for the production of the crystalline resin A1. In addition, each monomer unit forming the amorphous resin B1 was incorporated in the same proportions as the formulation for the production of the amorphous resin B 1.

### Comparative Examples 1 to 3 and 5 to 9

Comparative toner particles 1 to 3 and 5 to 9 were obtained proceeding entirely as in Example 1, but changing, as shown in Tables 2-1 and 2-2, the species and amount of addition of the polymerizable monomer that was used.

Comparative toners 1 to 3 and 5 to 9 were obtained by carrying out the same external addition as in Example 1. The properties of the toners are given in Tables 3-1 and 3-2, and the results of their evaluation are given in Table 4. Each monomer unit forming the crystalline resin A in comparative toners 1 to 3 and 5 to 9 was incorporated in the same proportions as the formulations described in Table 1. In addition, each monomer unit forming the amorphous resin B was incorporated in the same proportions as the formulations described in Tables 2-1 and 2-2.

### Comparative Example 4

A comparative toner particle 4 was obtained proceeding entirely as in Example 12, but changing the species and amounts of addition of the individual materials used as indicated below.

Comparative toner 4 was obtained by carrying out the same external addition as in Example 1. The properties of the toner are given in Tables 3-1 and 3-2, and the results of its evaluation are given in Table 4. Each monomer unit forming the crystalline resin A in comparative toner 4 was incorporated in the same proportions as the formulation described in Table 1.

| | | |
|---|---|---|
| crystalline resin A1 | 100.0 | parts |
| treated magnetic body | 65.0 | parts |
| release agent 1 | 9.0 | parts |

### Comparative Example 10

A comparative toner particle 10 was obtained proceeding entirely as in Example 12, but changing the species and amounts of addition of the individual materials used as indicated below.

Comparative toner 10 was obtained by carrying out the same external addition as in Example 1. The properties of the toner are given in Tables 3-1 and 3-2, and the results of its evaluation are given in Table 4. Each monomer unit forming the crystalline resin A in comparative toner 10 was incorporated in the same proportions as the formulation described in Table 1.

| | | |
|---|---|---|
| crystalline resin A1 | 80.0 | parts |
| resin C1 | 20.0 | parts |
| treated magnetic body | 65.0 | parts |
| release agent 1 | 9.0 | parts |

Toner Evaluation Methods

<1>Low-temperature fixability

The toner-filled process cartridge was held for 48 hours at 25° C. and a humidity of 40% RH. Using an LBP-712Ci that had been modified so as to operate even with the fixing unit detached, an unfixed image was output of an image pattern in which 10 mm×10 mm square images were equally distributed at 9 points over the entire transfer paper. The fixing onset temperature was evaluated using 0.80 mg/cm² for the toner laid-on level on the transfer paper. A4 paper (“Plover Bond paper”, 105 g/m², Fox River Paper Company) was used as the transfer paper.

The fixing unit of the LBP-712Ci was removed to the outside and was configured to operate even outside the laser beam printer, and this external fixing unit was used as the fixing unit. Fixing was carried out using this external fixing unit and a process speed of 240 mm/sec, with the fixation temperature being raised in 5° C. increments from a temperature of 90° C. The fixed image was visually checked; the lowest temperature at which cold offset did not occur was denoted the fixing onset temperature; and the low-temperature fixability was evaluated using the following criteria. The results of the evaluation are given in Table 4.

Evaluation Criteria
A: the fixing onset temperature is 100° C. or less
B: the fixing onset temperature is from 105° C. to 110° C.
C: the fixing onset temperature is from 115° C. to 120° C.
D: the fixing onset temperature is 125° C. or more

<2>Image durability

An evaluation of image bending was performed in order to evaluate the image durability.

The toner-filled process cartridge was held for 48 hours at a temperature of 15.0° C. and a humidity of 10% RH. Using an LBP-712Ci as the printer, a 50 mm×50 mm solid image was formed in the center of the transfer paper. Operating in the same environment, this image was folded 20 times continuously in the center, and the degree to which image exfoliation was produced in the solid image was then visually assessed.

The evaluation was performed using the following assessment criteria. The results of the evaluation are given in Table 4.

Evaluation Criteria
A: Image exfoliation is not observed.
B: Slight image exfoliation is observed at the location of the fold.
C: Image exfoliation is observed at the location of the fold, but this is not problematic at a practical level.
D: Image exfoliation is observed, including at locations outside of the fold.

<3>Heat-resistant storability

The heat-resistant storability was evaluated in order to evaluate the stability during storage. 5 g of the toner was introduced into a 100-mL plastic cup; this was held for 3 days in an environment with a temperature of 50° C. and a humidity of 40% RH; and the degree of toner aggregation was measured as described below and was evaluated using the criteria given below.

The following was used as the measurement instrumentation: a “Model 1332A Digital Vibration Meter” (Showa Sokki Co., Ltd.) digital display vibration meter connected to the side surface of the vibrating platform of a “Powder Tester” (Hosokawa Micron Corporation). The following were stacked, in sequence from the bottom, on the vibrating platform of the Powder Tester: a sieve with an aperture of 38 μm (400 mesh), a sieve with an aperture of 75 μm (200 mesh), and a sieve with an aperture of 150 μm (100 mesh). The measurement was performed as follows in a 23° C./60% RH environment.

1) The vibration amplitude of the vibrating platform was preliminarily adjusted so as to provide 0.60 mm (peak-to-peak) for the value of the displacement on the digital display vibration meter. [0342] (2) The toner held for 3 days as described above was preliminarily held for 24 hours in a 23° C./60% RH environment. 5.00 g of the toner was then exactly weighed out and was carefully loaded on the sieve having an aperture of 150 μm, which was in the uppermost position. [0343] (3) The screens were vibrated for 15 seconds; the mass of toner retained on each sieve was then measured; and the degree of aggregation was calculated on the basis of the following formula. The results of the evaluation are given in Table 4. [0344] degree of aggregation (%)={(sample mass (g) on the sieve with an aperture of 150 μm)/5.00 (g)}×100+{(sample mass (g) on the sieve with an aperture of 75 μm)/5.00 (g)}×100×0.6+{(sample mass (g) on the sieve with an aperture of 38 μm)/5.00 (g)}×100×0.2

Evaluation Criteria

A: the degree of aggregation is less than 10.0%

B: the degree of aggregation is at least 10.0%, but less than 15.0%

C: the degree of aggregation is at least 15.0%, but less than 20.0%

D: the degree of aggregation is 20.0% or more

<4>Developing Performance

Using an LBP-712Ci and operating in a high-temperature, high-humidity environment (temperature of 32.5° C. and humidity of 80% RH), 5,000 prints of an image with a print percentage of 2% were printed out using this printer. After standing for 7 days, 1 print of an image having a white background region was printed out. The reflectance of the obtained image was measured using a reflection densitometer (Model TC-6DS Reflectometer, Tokyo Denshoku Co., Ltd.). An amber filter was used for the filter used in the measurement.

Using Dr—Ds for the fogging where Ds (%) is the worst value of the reflectance of the white background region and Dr (%) is the reflectance of the transfer material prior to image formation, the evaluation is performed using the following criteria. The results of the evaluation are given in Table 4.

Evaluation Criteria
A: the fogging is less than 1.0%
B: the fogging is at least 1.0%, but less than 3.0%
C: the fogging is at least 3.0%, but less than 5.0%
D: the fogging is 5.0% or more

TABLE 4

| | | Low-temperature | | | | | | |
|---|---|---|---|---|---|---|---|---|
| | | fixability cold offset | | Image | Heat-resistant storability | | | |
| | | Fixing onset | | durability | Degree of | | Developing performance | |
| | | temperature | Evaluation | Evaluation | aggregation | Evaluation | Fogging | Evaluation |
| | Toner | (° C.) | rank | rank | 3 days/50° C. | rank | density | rank |
| Example 1 | Toner 1 | 95 | A | A | 6.8 | A | 0.6 | A |
| Example 2 | Toner 2 | 90 | A | B | 17.3 | C | 0.6 | A |
| Example 3 | Toner 3 | 105 | B | A | 7.2 | A | 0.6 | A |
| Example 4 | Toner 4 | 115 | C | A | 6.1 | A | 0.6 | A |
| Example 5 | Toner 5 | 105 | B | A | 6.3 | A | 0.6 | A |
| Example 6 | Toner 6 | 100 | A | A | 6.5 | A | 0.6 | A |
| Example 7 | Toner 7 | 90 | A | A | 6.8 | A | 2.5 | B |
| Example 8 | Toner 8 | 115 | C | A | 6.4 | A | 0.6 | A |
| Example 9 | Toner 9 | 110 | B | A | 7.0 | A | 0.6 | A |
| Example 10 | Toner 10 | 90 | A | B | 7.0 | A | 2.8 | B |
| Example 11 | Toner 11 | 90 | A | B | 12.6 | B | 2.9 | B |
| Example 12 | Toner 12 | 90 | A | C | 18.4 | C | 4.8 | C |
| Example 13 | Toner 13 | 95 | A | B | 7.1 | A | 2.0 | B |
| Example 14 | Toner 14 | 110 | B | B | 6.4 | A | 1.6 | B |
| Example 15 | Toner 15 | 115 | C | A | 7.1 | A | 0.3 | A |
| Example 16 | Toner 16 | 95 | A | A | 7.0 | A | 0.6 | A |
| Example 17 | Toner 17 | 115 | C | A | 19.1 | C | 0.6 | A |
| Example 18 | Toner 18 | 100 | A | C | 6.1 | A | 0.9 | A |
| Example 19 | Toner 19 | 115 | C | A | 6.1 | A | 0.6 | A |
| Example 20 | Toner 20 | 110 | B | A | 6.1 | A | 0.6 | A |
| Example 21 | Toner 21 | 100 | A | A | 13.9 | B | 0.6 | A |
| Example 22 | Toner 22 | 100 | A | B | 19.1 | C | 2.2 | B |
| Example 23 | Toner 23 | 100 | A | A | 7.3 | A | 0.6 | A |
| Example 24 | Toner 24 | 100 | A | A | 7.1 | A | 0.6 | A |
| Example 25 | Toner 25 | 100 | A | A | 8.3 | A | 0.6 | A |
| Example 26 | Toner 26 | 100 | A | A | 8.8 | A | 0.6 | A |
| Example 27 | Toner 27 | 105 | B | B | 13.9 | B | 2.4 | B |
| Example 28 | Toner 28 | 120 | C | C | 6.2 | A | 4.9 | C |
| C.E. 1 | C.T. 1 | 90 | A | B | 24.0 | D | 2.8 | B |
| C.E. 2 | C.T. 2 | 125 | D | A | 6.4 | A | 0.5 | A |
| C.E. 3 | C.T. 3 | 130 | D | A | 6.8 | A | 0.4 | A |
| C.E. 4 | C.T. 4 | 95 | A | D | 14.2 | B | 7.5 | D |
| C.E. 5 | C.T. 5 | 130 | D | A | 6.5 | A | 5.8 | D |
| C.E. 6 | C.T. 6 | 95 | A | A | 28.0 | D | 4.7 | C |
| C.E. 7 | C.T. 7 | 115 | C | D | 6.1 | A | 0.9 | A |
| C.E. 8 | C.T. 8 | 145 | D | D | 6.1 | A | 6.7 | D |
| C.E. 9 | C.T. 9 | 115 | C | D | 6.2 | A | 0.6 | A |
| C.E. 10 | C.T. 10 | 105 | B | D | 7.4 | A | 6.1 | D |

In the table, C. E. represents Comparative Example and C. T. represents Comparative Toner.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-100446, filed Jun. 22, 2022 which is hereby incorporated by reference herein in its entirety.

What is claimed is:

1. A magnetic toner comprising a toner particle, the toner particle comprising:
a magnetic body,
a crystalline resin A, and
an amorphous resin B, wherein
the crystalline resin A comprises a monomer unit (a) represented by formula (a);
the amorphous resin B comprises a monomer unit (b) represented by formula (b);
a content of the crystalline resin A in the toner is 6.2 to 77.0 mass %;
the sum of contents of the crystalline resin A and the amorphous resin B in the toner is 30.0 mass % or more;
a content of the monomer unit (a) in the crystalline resin A is 50.0 to 100.0 mass %; and
using SPA ((J/cm³)^{0.5}) for a SP value of the crystalline resin A and using SPB ((J/cm³)^{0.5}) for a SP value of the amorphous resin B, SPA and SPB satisfy 0.15≤SPB−SPA≤2.00: 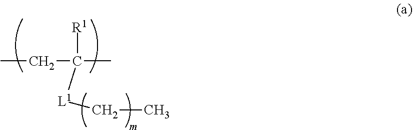
in formula (a), R¹ represents a hydrogen atom or a methyl group, L¹ represents a single bond or a divalent linking group, and m represents an integer from 15 to 35: 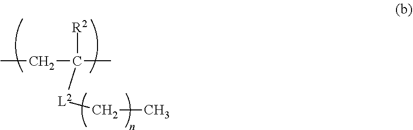
in formula (b), R² represents a hydrogen atom or a methyl group, L² represents a single bond or a divalent linking group, and n represents an integer from 10 to 30.

2. The toner according to claim 1, wherein a content of the amorphous resin B in the toner is 2.7 to 63.0 mass %.

3. The toner according to claim 1, wherein a content of the amorphous resin B in the toner is 20.0 to 55.0 mass %.

4. The toner according to claim 1, wherein a content of the monomer unit (b) in the amorphous resin B is 2.7 to 47.0 mass %.

5. The toner according to claim 1, wherein a content of the monomer unit (b) in the amorphous resin B is 5.0 to 40.0 mass %.

6. The toner according to claim 1, wherein a glass transition temperature of the amorphous resin B is 30.0 to 90.0° C.

7. The toner according to claim 1, wherein the monomer unit (a) is a monomer unit (a-1) represented by formula (a-1): 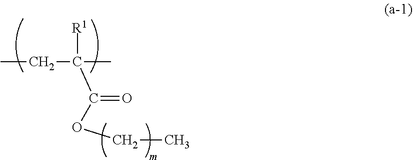
in formula (a-1), R¹ represents a hydrogen atom or a methyl group and m represents an integer from 15 to 35.

8. The toner according to claim 1, wherein the content of the crystalline resin A in the toner is 10.0 to 40.0 mass %.

9. The toner according to claim 1, wherein the content of the monomer unit (a) in the crystalline resin A is 65.0 to 90.0 mass %.

10. The toner according to claim 1, wherein the monomer unit (b) is a monomer unit (b-1) represented by formula (b-1): 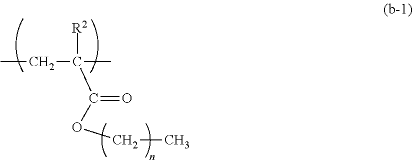
in the formula (b-1), R² represents a hydrogen atom or a methyl group and n represents an integer from 10 to 30.

11. The toner according to claim 1, wherein a content of the magnetic body in the toner is 7.0 to 45.0 mass %.
